(19) United States
(12) Patent Application Publication
(10) Pub. No.: US 2026/0107325 A1
(43) Pub. Date: Apr. 16, 2026

(54) ADAPTATION OF RANDOM ACCESS CONFIGURATION IN WIRELESS COMMUNICATIONS

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Ambarish TRIPATHI, San Diego, CA (US); Hung Dinh LY, San Diego, CA (US)

(21) Appl. No.: 19/356,969

(22) Filed: Oct. 13, 2025

Related U.S. Application Data
(60) Provisional application No. 63/707,663, filed on Oct. 15, 2024.

(51) Int. Cl. H04W 74/0833; H04W 68/02

(52) U.S. Cl. CPC H04W 74/0833; H04W 68/02

(57) ABSTRACT

Methods, systems, and devices for wireless communications are described that provide for adaptation of a physical random access channel (PRACH) configuration to change a quantity of random access occasions (ROs) available for transmission of a random access message from a user equipment (UE) subsequent to receipt of an activation signal at the UE. An additional PRACH configuration may be activated to provide an increased quantity of ROs for a time duration subsequent to the receipt of the activation signal at the UE. The start time of the activation of the additional PRACH configuration may be based on a time interval during which the signal is received at the UE. In the case that the UE receives multiple activation signals activating an additional PRACH configuration, the UE may determine the duration of the additional PRACH configuration in accordance with a rule for determination of the duration of the additional PRACH configuration.

### CROSS REFERENCES

The present Application for Patent claims benefit of U.S. Provisional Patent Application No. 63/707,663 by ABOTABL et al., entitled “ADAPTATION OF RANDOM ACCESS CONFIGURATION IN WIRELESS COMMUNICATIONS,” filed Oct. 15, 2024, assigned to the assignee hereof, and expressly incorporated herein.

### TECHNICAL FIELD

The following relates to wireless communications, including adaptation of random access configuration in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first signal that indicates a first random access configuration that includes a first pattern of first random access occasions available during a random access configuration period, receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and transmitting, after the start time, a random access message in a random access occasion of the second pattern of additional random access occasions based on the second random access configuration.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive a first signal that indicates a first random access configuration that includes a first pattern of first random access occasions available during a random access configuration period, receive, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and transmit, after the start time, a random access message in a random access occasion of the second pattern of additional random access occasions based on the second random access configuration.

Another UE for wireless communications is described. The UE may include means for receiving a first signal that indicates a first random access configuration that includes a first pattern of first random access occasions available during a random access configuration period, means for receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and means for transmitting, after the start time, a random access message in a random access occasion of the second pattern of additional random access occasions based on the second random access configuration.

A non-transitory computer-readable medium storing code for wireless communications at a UE is described. The code may include instructions executable by at least one processor (e.g., directly, indirectly, after pre-processing, without pre-processing) to receive a first signal that indicates a first random access configuration that includes a first pattern of first random access occasions available during a random access configuration period, receive, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and transmit, after the start time, a random access message in a random access occasion of the second pattern of additional random access occasions based on the second random access configuration.

In some examples of the method, UEs, and non-transitory computer-readable medium described herein, the time interval may be a slot and the reference time may be one of a beginning time or an end time of the slot.

In some examples of the method, UEs, and non-transitory computer-readable medium described herein, a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

In some examples of the method, UEs, and non-transitory computer-readable medium described herein, receiving the second signal may include operations, features, means, or instructions for receiving the second signal via a paging message during a paging cycle, where the time interval may be the paging cycle, and where the reference time may be one of: a beginning time or an end time of a temporally first slot within the paging cycle, a beginning time or an end time of a temporally last slot within the paging cycle, or a beginning time or an end time of a temporally first slot after the paging cycle.

In some examples of the method, UEs, and non-transitory computer-readable medium described herein, the start time may be offset from the reference time by a quantity of association periods in accordance with the first random access configuration.

In some examples of the method, UEs, and non-transitory computer-readable medium described herein, the start time may be offset from the reference time by a quantity of association periods in accordance with the second random access configuration.

In some examples of the method, UEs, and non-transitory computer-readable medium described herein, the start time may be offset from the reference time by a quantity of PRACH configuration periods.

Some examples of the method, UEs, and non-transitory computer-readable medium described herein may further include operations, features, means, or instructions for calculating a respective duration of each PRACH configuration period of the quantity of PRACH configuration periods using the first pattern of first random access occasions.

Some examples of the method, UEs, and non-transitory computer-readable medium described herein may further include operations, features, means, or instructions for calculating a respective duration of each PRACH configuration period of the quantity of PRACH configuration periods using the second pattern of additional random access occasions.

Some examples of the method, UEs, and non-transitory computer-readable medium described herein may further include operations, features, means, or instructions for calculating a respective duration of each PRACH configuration period of the quantity of PRACH configuration periods using both the first pattern of first random access occasions and the second pattern of additional random access occasions.

In some examples of the method, UEs, and non-transitory computer-readable medium described herein, the start time may be offset from the reference time by a quantity of association pattern periods.

In some examples of the method, UEs, and non-transitory computer-readable medium described herein, the start time may be offset from the reference time by a quantity of synchronization signal block (SSB) to random access occasion mapping cycles associated with the first pattern of first random access occasions.

In some examples of the method, UEs, and non-transitory computer-readable medium described herein, the start time may be offset from the reference time by a quantity of SSB to random access occasion mapping cycles associated with the second pattern of additional random access occasions.

Some examples of the method, UEs, and non-transitory computer-readable medium described herein may further include operations, features, means, or instructions for receiving, after receipt of the second signal and before an end of the time duration, a third signal that activates the second random access configuration and resetting, based on reception of the third signal, the time duration relative to a receipt time of the third signal.

Some examples of the method, UEs, and non-transitory computer-readable medium described herein may further include operations, features, means, or instructions for receiving, after receipt of the second signal and before an end of the time duration, a third signal that activates the second random access configuration and terminating activation of the second random access configuration at an end of the time duration.

Some examples of the method, UEs, and non-transitory computer-readable medium described herein may further include operations, features, means, or instructions for receiving, after receipt of the second signal and before an end of the time duration, a third signal that activates the second random access configuration and extending, based on reception of the third signal, the time duration from an end time of the time duration by a second duration equal to the time duration.

In some examples of the method, UEs, and non-transitory computer-readable medium described herein, the start time may be common to all UEs that receive an indication of the second random access configuration within the time interval.

A method for wireless communications by a network entity is described. The method may include outputting a first signal that indicates a first random access configuration that includes a first pattern of first random access occasions available during a random access configuration period, outputting, for one or more UEs and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and obtaining, from at least one of the one or more UEs and after the start time, a random access message in a random access occasion of the second pattern of additional random access occasions based on the second random access configuration.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to output a first signal that indicates a first random access configuration that includes a first pattern of first random access occasions available during a random access configuration period, output, for one or more UEs and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and obtain, from at least one of the one or more UEs and after the start time, a random access message in a random access occasion of the second pattern of additional random access occasions based on the second random access configuration.

Another network entity for wireless communications is described. The network entity may include means for outputting a first signal that indicates a first random access configuration that includes a first pattern of first random access occasions available during a random access configuration period, means for outputting, for one or more UEs and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and means for obtaining, from at least one of the one or more UEs and after the start time, a random access message in a random access occasion of the second pattern of additional random access occasions based on the second random access configuration.

A non-transitory computer-readable medium storing code for wireless communications at a UE is described. The code may include instructions executable by at least one processor (e.g., directly, indirectly, after pre-processing, without pre-processing) to output a first signal that indicates a first random access configuration that includes a first pattern of first random access occasions available during a random access configuration period, output, for one or more UEs and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval, and obtain, from at least one of the one or more UEs and after the start time, a random access message in a random access occasion of the second pattern of additional random access occasions based on the second random access configuration.

In some examples of the method, network entities, and non-transitory computer-readable medium described herein, the time interval may be a slot and the reference time may be one of a beginning time or an end time of the slot.

In some examples of the method, network entities, and non-transitory computer-readable medium described herein, a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

In some examples of the method, network entities, and non-transitory computer-readable medium described herein, outputting the second signal may include operations, features, means, or instructions for outputting the second signal via a paging message during a paging cycle, where the time interval may be the paging cycle, and where the reference time may be one of: a beginning time or an end time of a temporally first slot within the paging cycle, a beginning time or an end time of a temporally last slot within the paging cycle, or a beginning time or an end time of a temporally first slot after the paging cycle.

In some examples of the method, network entities, and non-transitory computer-readable medium described herein, the start time may be offset from the reference time by a quantity of association periods in accordance with the first random access configuration.

In some examples of the method, network entities, and non-transitory computer-readable medium described herein, the start time may be offset from the reference time by a quantity of association periods in accordance with the second random access configuration.

In some examples of the method, network entities, and non-transitory computer-readable medium described herein, the start time may be offset from the reference time by a quantity of PRACH configuration periods.

Some examples of the method, network entities, and non-transitory computer-readable medium described herein may further include operations, features, means, or instructions for calculating a respective duration of each PRACH configuration period of the quantity of PRACH configuration periods using the first pattern of first random access occasions.

Some examples of the method, network entities, and non-transitory computer-readable medium described herein may further include operations, features, means, or instructions for calculating a respective duration of each PRACH configuration period of the quantity of PRACH configuration periods using the second pattern of additional random access occasions.

Some examples of the method, network entities, and non-transitory computer-readable medium described herein may further include operations, features, means, or instructions for calculating a respective duration of each PRACH configuration period of the quantity of PRACH configuration periods using both the first pattern of first random access occasions and the second pattern of additional random access occasions.

In some examples of the method, network entities, and non-transitory computer-readable medium described herein, the start time may be offset from the reference time by a quantity of association pattern periods.

In some examples of the method, network entities, and non-transitory computer-readable medium described herein, the start time may be offset from the reference time by a quantity of SSB to random access occasion mapping cycles associated with the first pattern of first random access occasions.

In some examples of the method, network entities, and non-transitory computer-readable medium described herein, the start time may be offset from the reference time by a quantity of SSB to random access occasion mapping cycles associated with the second pattern of additional random access occasions.

Some examples of the method, network entities, and non-transitory computer-readable medium described herein may further include operations, features, means, or instructions for outputting, after output of the second signal and before an end of the time duration, a third signal that activates the second random access configuration and resetting, based on output of the third signal, the time duration relative to a receipt time of the third signal.

Some examples of the method, network entities, and non-transitory computer-readable medium described herein may further include operations, features, means, or instructions for outputting, after output of the second signal and before an end of the time duration, a third signal that activates the second random access configuration and terminating activation of the second random access configuration at an end of the time duration.

Some examples of the method, network entities, and non-transitory computer-readable medium described herein may further include operations, features, means, or instructions for outputting, after output of the second signal and before an end of the time duration, a third signal that activates the second random access configuration and extending, based on reception of the third signal, the time duration from an end time of the time duration by a second duration equal to the time duration.

Some examples of the method, network entities, and non-transitory computer-readable medium described herein may further include operations, features, means, or instructions for transmitting, within the time interval to one or more second UEs, one or more respective second signals that indicate the second random access configuration, where the start time may be common to the one or more UEs and the one or more second UEs.

A method for wireless communications by a UE is described. The method may include receiving a first signal that indicates a first random access configuration that includes a first pattern of first random access occasions available during a random access configuration period, receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time, receiving, after receipt of the second signal and before an end of the time duration, a third signal that activates the second random access configuration, and transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive a first signal that indicates a first random access configuration that includes a first pattern of first random access occasions available during a random access configuration period, receive, during the random access configuration period, a second signal that activates a second random access configuration that includes a second pattern of additional random access occasions, where at least a subset of additional random access occasions of the second pattern of additional random access occasions are available for transmission for a time duration beginning at a start time, receive, after receipt of the second signal and before an end of the time duration, a third signal that activates the second random access configuration, and transmit, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

Another UE for wireless communications is described. The UE may include means for receiving a first signal that indicates a first random access configuration that includes a first pattern of first random access occasions available during a random access configuration period, means for receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time, means for receiving, after receipt of the second signal and before an end of the time duration, a third signal that activates the second random access configuration, and means for transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

A non-transitory computer-readable medium storing code for wireless communications at a UE is described. The code may include instructions executable by at least one processor (e.g., directly, indirectly, after pre-processing, without pre-processing) to receive a first signal that indicates a first random access configuration that includes a first pattern of first random access occasions available during a random access configuration period, receive, during the random access configuration period, a second signal that activates a second random access configuration that includes a second pattern of additional random access occasions, where at least a subset of additional random access occasions of the second pattern of additional random access occasions are available for transmission for a time duration beginning at a start time, receive, after receipt of the second signal and before an end of the time duration, a third signal that activates the second random access configuration, and transmit, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

In some examples of the method, UEs, and non-transitory computer-readable medium described herein, resetting, in accordance with the rule, the time duration relative to a receipt time of the third signal.

Some examples of the method, UEs, and non-transitory computer-readable medium described herein may further include operations, features, means, or instructions for terminating, in accordance with the rule, activation of the second random access configuration at an end of the time duration.

Some examples of the method, UEs, and non-transitory computer-readable medium described herein may further include operations, features, means, or instructions for extending, in accordance with the rule, the time duration from an end time of the time duration by a second duration equal to the time duration.

A method for wireless communications by a network entity is described. The method may include outputting a first signal that indicates a first random access configuration that includes a first pattern of first random access occasions available during a random access configuration period, outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time, outputting, to the one or more UEs after output of the second signal and before an end of the time duration, a third signal that activates the second random access configuration, and obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to output a first signal that indicates a first random access configuration that includes a first pattern of first random access occasions available during a random access configuration period, output, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time, output, to the one or more UEs after output of the second signal and before an end of the time duration, a third signal that activates the second random access configuration, and obtain, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

Another network entity for wireless communications is described. The network entity may include means for outputting a first signal that indicates a first random access configuration that includes a first pattern of first random access occasions available during a random access configuration period, means for outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time, means for outputting, to the one or more UEs after output of the second signal and before an end of the time duration, a third signal that activates the second random access configuration, and means for obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

A non-transitory computer-readable medium storing code for wireless communications at a UE is described. The code may include instructions executable by at least one processor (e.g., directly, indirectly, after pre-processing, without pre-processing) to output a first signal that indicates a first random access configuration that includes a first pattern of first random access occasions available during a random access configuration period, output, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time, output, to the one or more UEs after output of the second signal and before an end of the time duration, a third signal that activates the second random access configuration, and obtain, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

In some examples of the method, network entities, and non-transitory computer-readable medium described herein, resetting, in accordance with the rule, the time duration relative to a receipt time of the third signal.

Some examples of the method, network entities, and non-transitory computer-readable medium described herein may further include operations, features, means, or instructions for terminating, in accordance with the rule, activation of the second random access configuration at an end of the time duration.

Some examples of the method, network entities, and non-transitory computer-readable medium described herein may further include operations, features, means, or instructions for extending, in accordance with the rule, the time duration from an end time of the time duration by a second duration equal to the time duration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports adaptation of random access configuration in wireless communications in accordance with one or more aspects of the present disclosure.

FIG. 2 shows an example of a wireless communications system that supports adaptation of random access configuration in wireless communications in accordance with one or more aspects of the present disclosure.

FIG. 3 shows an example of a paging occasion diagram that supports adaptation of random access configuration in wireless communications in accordance with one or more aspects of the present disclosure.

FIG. 4 shows an example of a physical random access channel (PRACH) association period diagram that supports adaptation of random access configuration in wireless communications in accordance with one or more aspects of the present disclosure.

FIG. 5 shows an example of a timing diagram that supports adaptation of random access configuration in wireless communications in accordance with one or more aspects of the present disclosure.

FIG. 6 shows an example of a timing diagram that supports adaptation of random access configuration in wireless communications in accordance with one or more aspects of the present disclosure.

FIG. 7 shows examples of timing diagrams that supports adaptation of random access configuration in wireless communications in accordance with one or more aspects of the present disclosure.

FIG. 8 shows an example of a process flow that supports adaptation of random access configuration in wireless communications in accordance with one or more aspects of the present disclosure.

FIG. 9 shows an example of a process flow that supports adaptation of random access configuration in wireless communications in accordance with one or more aspects of the present disclosure.

FIGS. 10 and 11 show block diagrams of devices that support adaptation of random access configuration in wireless communications in accordance with one or more aspects of the present disclosure.

FIG. 12 shows a block diagram of a communications manager that supports adaptation of random access configuration in wireless communications in accordance with one or more aspects of the present disclosure.

FIG. 13 shows a diagram of a system including a device that supports adaptation of random access configuration in wireless communications in accordance with one or more aspects of the present disclosure.

FIGS. 14 and 15 show block diagrams of devices that support adaptation of random access configuration in wireless communications in accordance with one or more aspects of the present disclosure.

FIG. 16 shows a block diagram of a communications manager that supports adaptation of random access configuration in wireless communications in accordance with one or more aspects of the present disclosure.

FIG. 17 shows a diagram of a system including a device that supports adaptation of random access configuration in wireless communications in accordance with one or more aspects of the present disclosure.

FIGS. 18 through 21 show flowcharts illustrating methods that support adaptation of random access configuration in wireless communications in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as new radio (NR) systems, or other systems and radio technologies, including future systems and radio technologies not explicitly mentioned herein (e.g., sixth generation (6G) systems and beyond).

In some wireless communications systems, such as fifth generation (5G) or NR systems, a relatively large amount of power may be consumed by network components in some situations. For example, a network entity in a system that uses beamformed communications, such as a radio unit (RU) or a radio head, may transmit multiple directional beams in multiple directions. Such systems may provide information for use by a UE to access the wireless communications system (e.g., system information that provides parameters for system access) using beam sweeping techniques in which information is provided in multiple different transmissions in multiple different directions. The network entity may also monitor random access channel (RACH) occasions (ROs) for random access messages that are transmitted from UEs, where a RO pattern may include a number of ROs that are to be monitored, and where different ROs may be associated with different beams (e.g., mapped to different synchronization signal blocks (SSBs)).

In some cases, in order to reduce network power consumption, a network entity may transition to a sleep mode or non-active mode in which some or all transmit and receive circuitry is powered down. For example, during off-peak times, there may be no traffic or a light traffic load in a cell, and the network entity may stop or reduce periodic transmissions (e.g., SSB and system information (SI) transmissions) and periodic monitoring (e.g., monitoring of ROs, and/or monitoring for configured grant uplink (CG) transmissions or small data transmission (SDT) communications), and transition to a non-active mode (e.g., in which periodic active periods may be used to monitor ROs). In some cases, it may be useful to temporarily increase the number of ROs available to a UE to transmit a random access message, such as when a UE is paged or based on quantity of UEs within a service area of a cell. Increasing a quantity of available ROs may allow for reduced latency by allowing the UE to transmit a RACH request sooner than in cases where a reduced number of ROs are available.

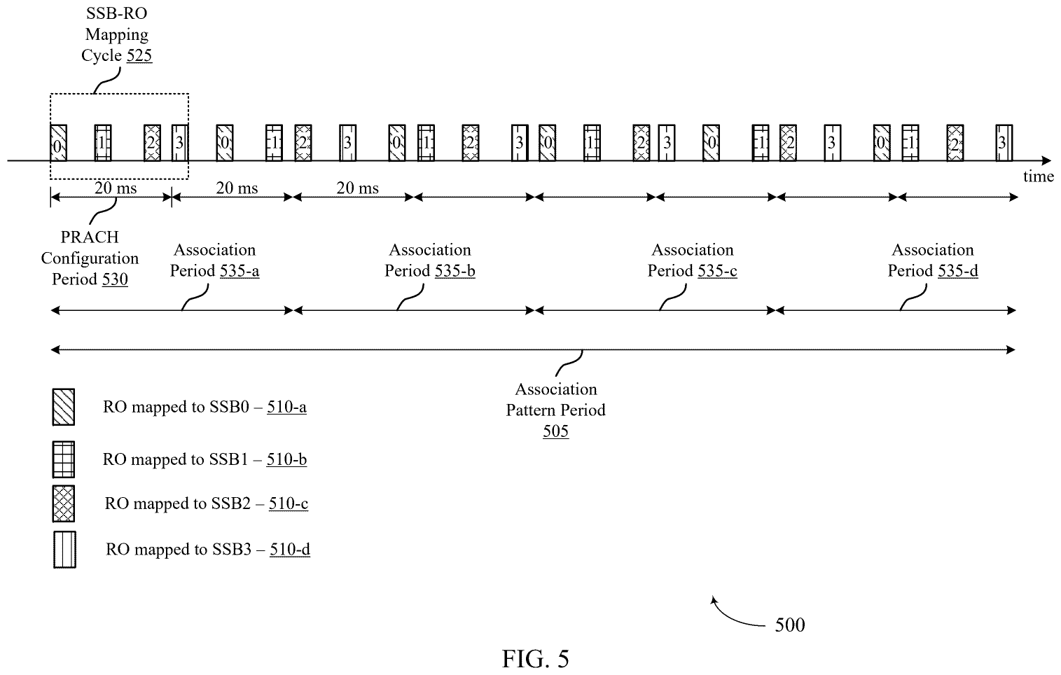

In some wireless communication systems, ROs and RO patterns may be configured in a physical random access channel (PRACH) configuration that provides patterns of ROs within RACH association periods that are defined within a PRACH association pattern period. As described with reference to FIG. 5, a RACH association period (also referred to as an association period) may be a period during which each SSB indicated by as being transmitted by the network entity (e.g., in RRC signaling or SI) is mapped to an RO. As described with reference to FIG. 5, a PRACH association pattern period (also referred to as an association pattern period) may be 160 milliseconds (ms), which may be the maximum PRACH configuration period. PRACH configurations may be configured via SI such as system information block (SIB) 1 (SIB1). For example, PRACH configurations may be indicated in the RACH-ConfigCommon and/or RACH-ConfigGeneric fields. In order to change configured ROs in such systems, a new PRACH configuration may be provided to a UE via SIB1, which may involve time and overhead. For example, SIB1 may be transmitted by the network entity at a relatively low periodicity. Thus, efficient signaling of an adapted RO pattern that may be temporarily applied at a UE may be beneficial.

In some examples, a second PRACH configuration may be activated to change a quantity of ROs available for transmission of a random access message for a UE. The second PRACH configuration may be activated in addition to a first (e.g., original) PRACH configuration. Accordingly, when the second PRACH configuration is activated, a pattern of the original set of ROs and a pattern of additional ROs may be available to the UE. A network entity may activate a second PRACH configuration (e.g., a pattern of one or more additional ROs) via a paging message (e.g., in a paging early indicator (PEI), paging downlink control information (DCI), or paging physical downlink shared channel (PDSCH) transmission) or via an explicit indication (e.g., a new DCI) that activates the second PRACH configuration. The second PRACH configuration may include a pattern of additional ROs (e.g., in addition to the original set of ROs available in accordance with the first PRACH configuration configured by SIB1). For example, a second RO configuration may be indicated by SI (e.g., semi-statically via SIB1 or radio resource control (RRC) signaling), and the activation signaling from the network entity may activate the configured second PRACH configuration. For example, SIB1 may indicate both the first PRACH configuration and the second PRACH configuration, but the network entity 105 may not monitor the additional ROs of the second PRACH configuration except during periods during which the network entity activates the second PRACH configuration.

In some DCI-based approaches for adaptation of additional PRACH resources, the DCI-based adaptation may indicate whether the additional PRACH resources provided by semi-stative signaling (e.g., configured by a SIB1 or RRC signaling) are available. In some DCI-based approaches for adaptation of additional PRACH resources, the DCI-based adaptation may indicate whether a subset of additional PRACH resources provided by semi-static signaling are available. For example, the subset of additional PRACH resources may be: RO level per SSB; SSB-to-RO mapping cycle level; PRACH association period level; PRACH association pattern period level; or system frame number (SFN) level. In some DCI-based approaches for adaptation of additional PRACH resources, the DCI-based adaptation may be a DCI-based enhanced or new cell discontinuous reception (DRX) to indicate whether the enhanced/new cell DRX is activated or deactivated. If activated, the additional configured PRACH provided by semi-static signaling (e.g., SIB1) within the non-active period of the cell DRX may not be available.

A UE may benefit from having sufficient time to adapt to the second PRACH configuration, and accordingly, the pattern of additional ROs associated with the second PRACH configuration may be applied (e.g., activated) beginning at a start time relative to reception of the paging message that activates the second RACH configuration. The network entity may transmit paging messages to different UEs at different times, and accordingly, absent a set reference time, the additional ROs of the second PRACH configuration may be available to the different UEs at different starting times.

The starting time for activation of the second PRACH configuration may be based on a reference time that is based on the time interval during which the paging message is received by the UE. For example, each UE that receives a paging message within the same time interval that activates an additional PRACH configuration may begin application of the additional PRACH configuration at the same start time, even if the paging messages are not received by the UEs at the same time. Accordingly, each of those UEs may use the additional ROs of the updated RACH configuration. For example, the time interval may be a slot, and the reference time may be the beginning or end time of the slot. As another example, the time interval may be a frame, and the reference time may be the start or end time of the first/last slot of the frame, start or end time of the first/last subframe, and/or the start or end time of the frame. As another example, the time interval may be a paging cycle, and the and the reference time may be the start or end time of the first/last slot of the frame. Additionally, or alternatively, an offsets used to define the start time with reference to the reference time may be defined consistently across the multiple UEs such that each UE that receives a paging message within a time interval determines the same start time for the updated RACH configuration. For example, the offset may be a defined quantity of association periods (e.g., determined in accordance with the original or additional ROs), a defined quantity of association pattern periods, a defined quantity of association, a defined quantity of SSB to RO mapping cycles, or a defined quantity of PRACH configuration periods.

Aspects of the disclosure are initially described in the context of wireless communications systems. Aspects of the disclosure are further illustrated by and described with reference to paging occasion diagrams, PRACH association period diagrams, timing diagrams, process flows, apparatus diagrams, system diagrams, and flowcharts that relate to adaptation of random access configuration in wireless communications.

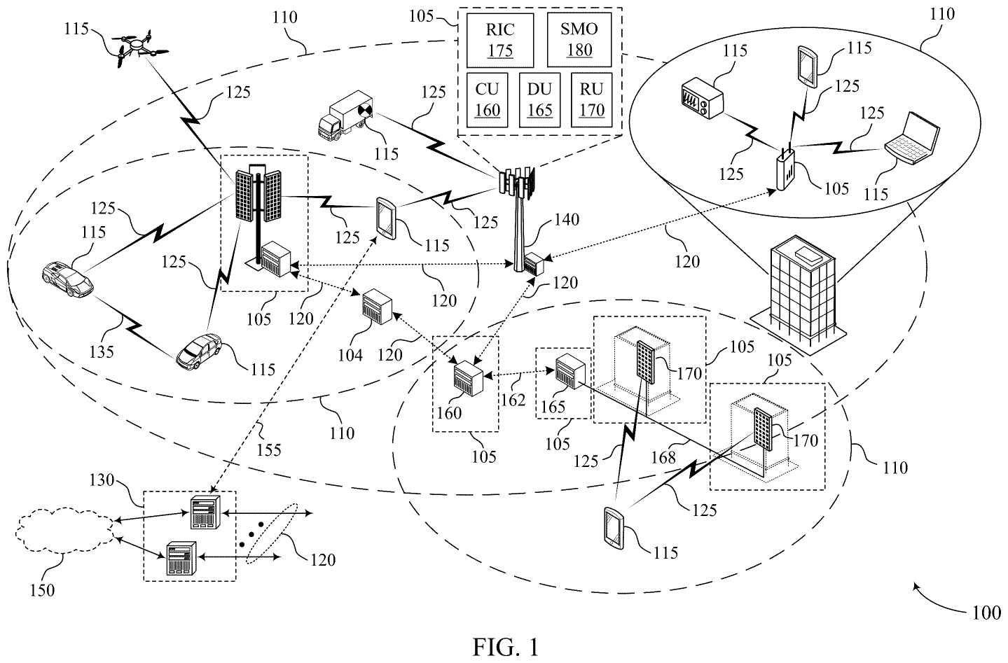

FIG. 1 shows an example of a wireless communications system 100 that supports adaptation of random access configuration in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, an RU, such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support adaptation of random access configuration in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, UEs 115 may be provided a PRACH configuration that indicates a pattern of ROs that are available for transmission of RACH messages. In accordance with various aspects, techniques are described that provide for activation of an additional PRACH configuration to change a quantity of ROs available for transmission of a RACH message from a UE 115 subsequent to receipt of an activation signal at the UE 115. In some aspects, a quantity of ROs may be increased by activation of the additional PRACH configuration for a time duration subsequent to the receipt of the activation signal at the UE 115, which may reduce a latency for UE 115 access to a network entity 105 in response to receiving the activation signal. In some examples, the starting time for the activation of the additional PRACH configuration may be based on a time interval during which the activation signaling for the activation of the additional PRACH configuration is received.

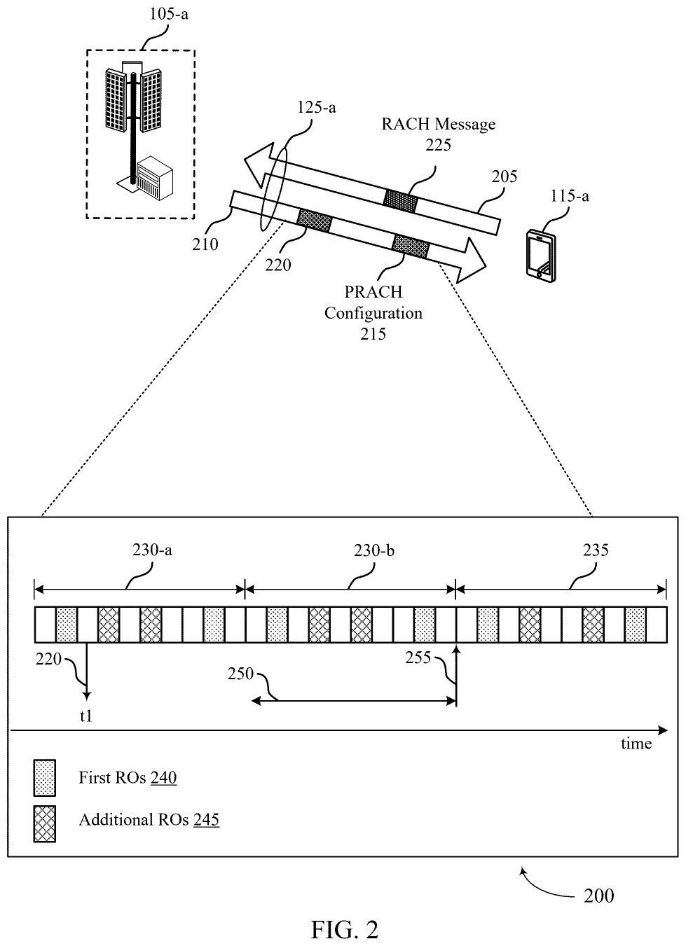

FIG. 2 shows an example of a wireless communications system 200 that supports adaptation of random access configuration in wireless communications in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include a bi-directional link that enables both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a. In some cases, communication link 125-a may include multiple component carriers.

The network entity 105-a may transmit control signaling 215 that may indicate a first PRACH configuration (e.g., a first random access configuration). The first PRACH configuration may include a pattern of first ROs 240. In some examples, the control signaling 215 may be a SIB, such as a SIB1. In some examples, the control signaling 215 may indicate an activatable second PRACH configuration that may include a second pattern of additional ROs 245. For example, the additional ROs may be activatable by a signal such as a PEI, a paging DCI, a paging PDSCH, or another type of DCI configured to activate an activatable second PRACH configuration that may include a second pattern of additional ROs 245. In some examples, the activation signal 220 may be a DCI of format 1_0, format 1_7, or format 2_9. In some examples, a paging radio network temporary identifier (P-RNTI), a system information RNTI (SI-RNTI), a cell discontinuous transmission and reception RNTI (CDTRX-RNTI), a PEI-RNTI, or a cell RNTI (C-RNTI), or a new RNTI may be used to detect the DCI format (e.g., may indicate the target UE 115 of the DCI).

To save energy, the network entity 105-a may refrain from monitoring the additional ROs 245 for RACH transmissions from UEs 115 unless the additional ROs 245 are activated. The network entity 105-a may activate the additional ROs 245, for example, during high traffic conditions (e.g., when a large quantity of UEs 115 attempt to communicate with the network entity 105-a).

For example, the network entity 105-a may be capable of one or more dynamic adaptations to save energy based on traffic conditions, such as PRACH adaptation as described herein. As another example, the network entity 105-a may adapt SSBs to save energy (e.g., by reducing SSB periodicity). As another example, PRACH configurations may be adapted in the time domain or the spatial domain (e.g., non-uniform PRACH resources per SSB). As another example, paging occasions may be adapted, including confining paging occasions in the time domain.

The network entity 105-a may transmit an activation signal 220 that activates the second PRACH configuration. For example, the activation signal 220 may be transmitted by the network entity 105-a and received by the UE 115-a at time t1 during a first PRACH configuration period 230-a. During the first PRACH configuration period 230-a the first ROs 240 are available for transmission of a RACH message but the additional ROs 245 are not available for transmission of a RACH message. The additional ROs 245 may be available for transmission of a RACH message during a PRACH configuration period 235 after an offset 250 after the activation signal 220. For example, the UE 115-a may transmit a RACH message 225 in an additional RO 245 during the PRACH configuration period 235. For example, a RACH message 225 may be a msg1 or a msgA.

The start time 255 of the PRACH configuration period 235 during which the second PRACH configuration (e.g., which includes the additional ROs 245) is activated may be based on the time interval during which the activation signal 220 is received. For example, the start time 255 may be an offset 250 after a time interval during which the activation signal 220 is received. In some examples, the offset may be zero (e.g., the additional ROs 245 may be available as soon as the activation signal 220 is received by the UE 115-a).

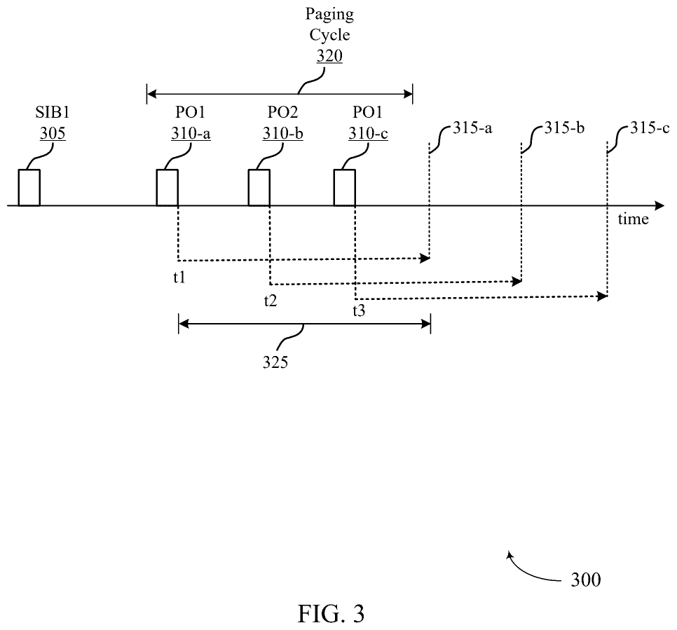

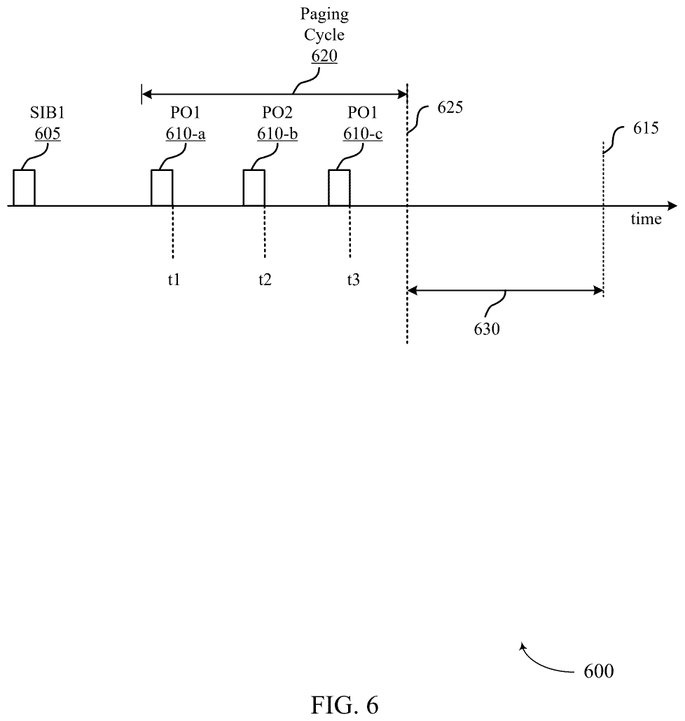

In some examples, as described with reference to FIGS. 3 and 6, the network entity 105-a may transmit paging messages (e.g., activation signals 220) that activate the second PRACH configuration to different UEs 115 (e.g., including the UE 115-a) at different times. If the offset (e.g., the time between reception of an activation signal for a second PRACH configuration and the start time 255 of the activation of the second PRACH configuration) is determined based on the time at which the activation signal is received, then the activation starting time for the different UEs 115 may be different. To align the start time 255 of the second PRACH configuration for different UEs 115 that receive paging messages at different times, and therefore to enable the different UEs 115 to use the same additional ROs 245, the start time 255 of the activation of the second PRACH configuration may be based on a reference time, where the reference time may be based on the time which a respective UE 115 receives the activation signal (e.g., t1 at which the activation signal 220 is received by the UE 115-a).

For example, the reference time may be the slot in which the activation signal (e.g., the PEI, paging DCI, paging PDSCH, or other DCI) is received. For example, from the slot in which the activation signal is received, the UE 115-a may begin determining the activation timing of the second PRACH configuration. As another example, the reference time may be the beginning or the end of the first or last slot of the frame in which the activation signal is received. As another example, the reference time may be the beginning or the end of the first or last subframe of the frame in which the activation signal is received. As another example, the reference time may be the beginning or the end of the frame in which the activation signal is received. As another example, the reference time may be the beginning or the end of the first or last slot of the paging cycle in which the indication was received.

In some examples, the offset 250 (e.g., the duration between the reference time and the time at which the second PRACH configuration is activated) may be a defined quantity of association periods calculated based on the pattern of first ROs 240 (e.g., based on the first PRACH configuration). In some examples, the offset 250 may be a defined quantity of association periods calculated based on the pattern of additional ROs 245 (e.g., based on the first PRACH configuration). In some examples, the offset 250 may be a defined quantity of association pattern periods. In some examples, the offset may be a defined quantity of SSB-RO mapping cycles (e.g., based on the first ROs and/or the additional ROs).

In some examples, as shown in FIG. 2, the offset may be a defined quantity of PRACH configuration periods. For example, as shown in FIG. 2, the second PRACH configuration may be activated two PRACH configuration periods after reception of the activation signal 220 (e.g., the second PRACH configuration may not be activated for the PRACH configuration period 230-b but the second PRACH configuration may be activated for the PRACH configuration period 235). In some examples, the PRACH configuration period may be calculated based only on the resources of the first ROs 240 (e.g., based on the first PRACH configuration). In some examples, the PRACH configuration period may be calculated based only on the resources of the additional ROs 245 (e.g., based on the second PRACH configuration). In some examples, the PRACH configuration period may be calculated based on the periodicity of the resources of the first ROs 240 and the additional ROs 245 (e.g., based on the first PRACH configuration and the second PRACH configuration).

FIG. 3 shows an example of a paging occasion diagram 300 that supports adaptation of random access configuration in wireless communications in accordance with one or more aspects of the present disclosure. The paging occasion diagram 300 may implement or may be implemented by aspects of the wireless communications system 100 or the wireless communications system 200.

As described herein, a network entity 105-a may transmit paging messages (e.g., PEIs, paging DCI, paging PDSCH) in paging occasions 310 to UEs 115 that may indicate an activation of an additional PRACH configuration. For example, a paging message transmitted in a paging occasion 310 may be a DCI format 1_0 with a cyclic redundancy check (CRC) scrambled by a P-RNTI. As described in section 7.3.1.2.1 of the 3rd Generation Partnership Project, v18.4.0 of TS 38.212 v18.4.0, the following information may be transmitted by means of the DCI format 1_0 with CRC scrambled by P-RNTI: Short Messages Indicator-2 bits; Short Messages-8 bits (if only the scheduling information for Paging, and tracking reference signal (TRS) availability indication if trs-ResourceSetConfig or trs-ResourceSetConfig-r18 is configured, are carried, this bit field may be reserved; Frequency domain resource assignment—

$$⌈ {log}_{2} ( {N}_{RB}^{DL , BWP} ( {N}_{RB}^{DL , BWP} + 1 ) / 2 ) ⌉$$

bits (if only the short message, and TRS availability indication if trs-ResourceSetConfig or trs-ResourceSetConfig-r18 is configured, are carried, this bit field may be reserved);

$${N}_{RB}^{DL , BWP}$$

is the size of CORSET 0, Time domain resource assignment-4 bits (if only the short message, and TRS availability indication if trs-ResourceSetConfig or trs-ResourceSetConfig-r18 is configured, are carried, this bit field may be reserved); virtual resource block (VRB)-to-physical resource block (PRB) mapping-1 bit (if only the short message, and TRS availability indication if trs-ResourceSetConfig or trs-ResourceSetConfig-r18 is configured, are carried, this bit field may be reserved); Modulation and coding scheme-5 bits (if only the short message, and TRS availability indication if trs-ResourceSetConfig or trs-ResourceSetConfig-r18 is configured, are carried, this bit field may be reserved); transport block (TB) scaling-2 bits (if only the short message, and TRS availability indication if trs-ResourceSetConfig or trs-Resource SetConfig-r18 is configured, are carried, this bit field may be reserved); TRS availability indication-1, 2, 3, 4, 5, or 6 bits, where the number of bits is equal to one plus the highest value of all the indBitll) (s) provided by the trs-ResourceSetConfig if configured or the number of bits is equal to one plus the highest value of all the indBitll)-r18(s) provided by the trs-Resource SetConfig-r18 if configured, and 0 bits otherwise; Reserved bits-(8-M) bits for operation in a cell with shared spectrum channel access in frequency range 1 or for operation in a cell in frequency range 2-2; (6-M) bits for operation in a cell without shared spectrum channel access, where the value of M is the number of bits for the field of ‘TRS availability indication’.

Table 1 shows example short message indicator field values in a DCI format 1_0 with CRC scrambled by P-RNTI.

TABLE 1

| Bit field | Short Message indicator |
|---|---|
| 00 | Reserved |
| 01 | Only scheduling information for Paging, and TRS |
| | availability indication if trs-ResourceSetConfig |
| | is configured, are present in the DCI |
| 10 | Only short message, and TRS availability indication |
| | if trs-ResourceSetConfig is configured, |
| | are present in the DCI |
| 11 | Both scheduling information for Paging, TRS |
| | availability indication if trs-ResourceSetConfig |
| | is configured and short message are present in the DCI |

Short messages may be transmitted on physical downlink control channel (PDCCH) (using P-RNTI with or without associated paging messages using the short message field in DCI format 1_0. Table 2 may define example short messages, with Bit 1 being the most significant bit.

TABLE 2

| Bit | Short Message |
|---|---|
| 1 | systemInfoModification: If set to 1: indication of a broadcast |
| | control channel (BCCH) modification other than SIB6, SIB7, |
| | SIB8 and posSIBs. |
| 2 | etwsAndCmasIndication: If set to 1: indication of an ETWS |
| | primary notification and/or an ETWS secondary notification |
| | and/or a CMAS notification. |
| 3 | StopPagingMonitoring: This bit can be used for only operation |
| | with shared spectrum channel access and if nrofPDCCH- |
| | MonitoringOccasionPerSSB-InPO is present. If set to 1: |
| | indication that the UE may stop monitoring PDCCH |
| | occasion(s) for paging in this Paging Occasion. |
| 4 | systemInfoModification-eDRX: If set to 1: indication of a |
| | BCCH modification other than SIB6, SIB7, SIB8 and posSIBs. |
| | This indication applies only to UEs using IDLE eDRX cycle |
| | longer than the BCCH modification period. |
| 5-8 | Not used/reserved and ignored by the UE |

UEs 115 may be grouped into paging groups. For example, a first set of UEs 115 may monitor a paging occasion 310-a for a first paging message at a first time t1, a second set of UEs 115 may monitor a second paging occasion 310-b for a second paging message at a second time t2, and a third set of UEs 115 may monitor a third paging occasion 310-c for a third paging message at a third time t3. A SIB1 305 may indicate scheduling information for a paging cycle 320 for the paging occasions 310 (e.g., may indicate to UEs 115 which paging occasions 310 to monitor within the paging cycle 320).

The paging messages in the paging occasions 310 may activate a second PRACH configuration (e.g., may activate additional ROs available for transmission of RACH messages by the UEs 115). If the activation is an offset 325 after the corresponding paging occasion 310 for each set of UEs 115, each set of UEs may have different starting times for activation of the second PRACH configuration. For example, the start time 315-a of the activation of the second PRACH configuration for the first set of UEs 115 may be the offset 325 after t1. Similarly, the start time 315-b of the activation of the second PRACH configuration for the second set of UEs 115 may be the offset 325 after t2, and the start time 315-c of the activation of the second PRACH configuration for the third set of UEs 115 may be the offset 325 after t3. Accordingly, based on the order of the paging occasions 310, some of the additional ROs may be available to the first set of UEs 115 and not the second and third sets of UEs 115, and some of the additional ROs may be available to the first set of UEs 115 and the second set of UEs 115 but not the third set of UEs 115. In some examples, as described herein, the start times 315 may be based on a reference time to unify start times 315 for the activation of the second PRACH configuration across UEs 115 that receive the activation signaling (e.g., paging messages that activate the second PRACH configuration) at different times.

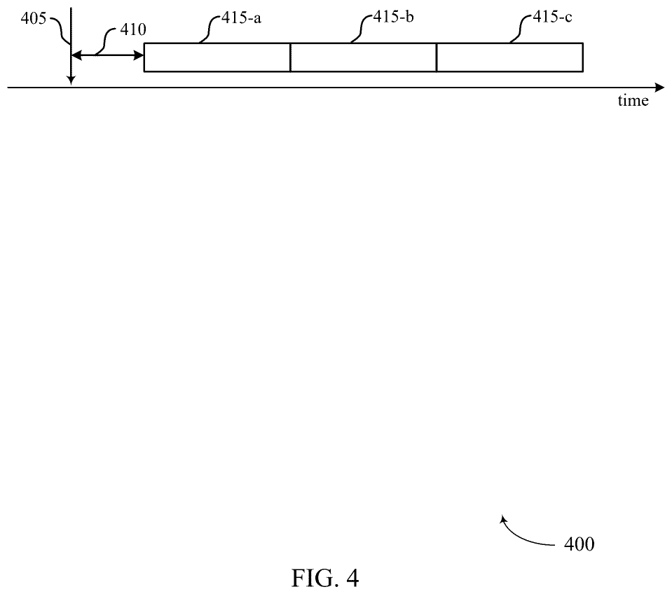

FIG. 4 shows an example of a PRACH configuration diagram 400 that supports adaptation of random access configuration in wireless communications in accordance with one or more aspects of the present disclosure. The PRACH configuration diagram 400 may implement or may be implemented by aspects of the wireless communications system 100 or the wireless communications system 200.

In some examples, as described herein, a SIB1 or other semi-static signaling may configure additional ROs that may be activated by the network entity (e.g., via an activation signal such as a paging message). The activation signaling 405 may activate a subset of the additional ROs configured by the semi-static signaling. For example, the activation signaling may activate additional ROs within one or more association periods 415 (e.g., after an offset 410 after the activation signaling 405). In some examples, the offset 410 may be zero (e.g., the second PRACH configuration may be immediately activated by the activation signaling 405). For example, the additional ROs within the association period 415-a may be activated by the activation signaling. A time duration of the activation period for the second PRACH configuration may be defined in terms of activation periods. For example, if the time duration is three association periods, in accordance with the second PRACH configuration, the additional ROs may be available in the association period 415-a, the association period 415-b, and the association period 415-c. As another example, if the time duration is two association periods, in accordance with the second PRACH configuration, the additional ROs may be available in the association period 415-a and the association period 415-b, and may not be available in the association period 415-c. As another example, if the time duration is one association period, in accordance with the second PRACH configuration, the additional ROs may be available in the association period 415-a and may not be available in the association period 415-b and the association period 415-c.

FIG. 5 shows an example of a timing diagram 500 that supports adaptation of random access configuration in wireless communications in accordance with one or more aspects of the present disclosure. The timing diagram 500 may implement or may be implemented by aspects of the wireless communications system 100 or the wireless communications system 200.

A PRACH configuration period 530 may refer to a quantity of frames in which a pattern of ROs 510 repeats (e.g., where the time and frequency resources in which the ROs 510 are scheduled repeat), where a frame may be 10 ms. For example, as shown in FIG. 5, a PRACH configuration period 530 may be 2 frames (e.g., 20 ms). Other PRACH configuration period durations may also be configured or used.

Each RO 510 may be mapped to an SSB. For example, as shown in the example of FIG. 5, the ROs may be mapped to one of four SSBs (e.g., ROs 510-a may be mapped to SSB 0, ROs 510-b may be mapped to SSB 1, ROs 510-c may be mapped to SSB 2, and ROs 510-d may be mapped to SSB 3). An SSB-RO mapping cycle 525 may refer to the period during which one RO 510 is mapped to all of the SSBs. An association period 535 may refer to the quantity of PRACH configuration periods in which each SSB is mapped to at least one RO. For example, each of the association period 535-a, the association period 535-b, the association period 535-c, and the association period 535-d may be two PRACH configuration periods (e.g., 40 ms). An association pattern period 505 may be 160 ms, which may be the maximum PRACH configuration periodicity. Accordingly, within 160 ms, the pattern of ROs (e.g., in terms of time and frequency resources and RO-SSB mappings).

FIG. 6 shows an example of a timing diagram 600 that supports adaptation of random access configuration in wireless communications in accordance with one or more aspects of the present disclosure. The timing diagram 600 may implement or may be implemented by aspects of the wireless communications system 100 or the wireless communications system 200.

As described herein, a network entity 105-a may transmit paging messages (e.g., PEIs, paging DCI, paging PDSCH) in paging occasions 310 to UEs 115 that may indicate an activation of an additional PRACH configuration. As shown in FIG. 6, the start time 615 of activation of the additional PRACH configuration may be based on a reference time 625 (e.g., based on an offset 630 with respect to the reference time 625).

For example, UEs 115 may be grouped into paging groups. For example, a first set of UEs 115 may monitor a paging occasion 610-a for a first paging message at a first time t1, a second set of UEs 115 may monitor a second paging occasion 610-b for a second paging message at a second time t2, and a third set of UEs 115 may monitor a third paging occasion 610-c for a third paging message at a third time t3. A SIB1 605 may indicate scheduling information a paging cycle 620 for the paging occasions 610 (e.g., may indicate to UEs 115 which paging occasions 610 to monitor within the paging cycle 620). The paging messages in the paging occasions 610 may activate a second PRACH configuration (e.g., may activate additional ROs for transmission of RACH messages by the UEs 115).

As shown in FIG. 6, the reference time 625 may be an end of the paging cycle (e.g., an end of a last slot of the paging cycle 620). Accordingly each of the first set of UEs 115 that monitor the paging occasion 610-a, the second set of UEs 115 that monitor the second paging occasion 610-b, and the third set of UEs 115 that monitor the third paging occasion 610-c may use the start time 615 (e.g., the same start time) based on using the reference time 625 (e.g., the end of the paging cycle 620).

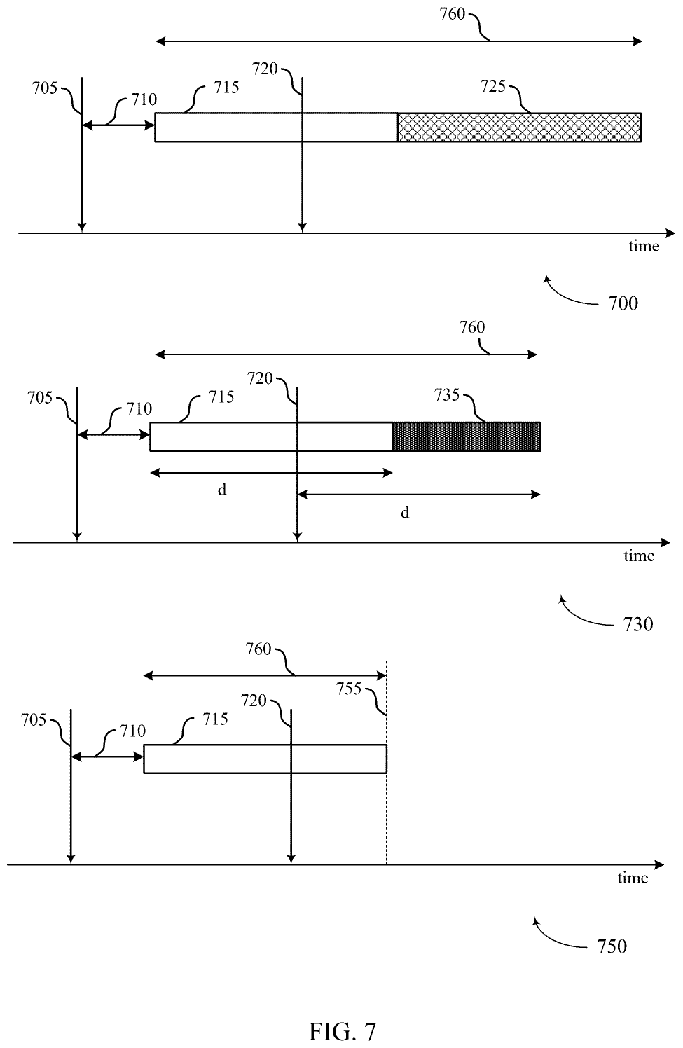

FIG. 7 shows an example of a timing diagram 700, a timing diagram 730, and a timing diagram 750 that supports adaptation of random access configuration in wireless communications in accordance with one or more aspects of the present disclosure. The timing diagram 700, the timing diagram 730, and the timing diagram 750 may implement or may be implemented by aspects of the wireless communications system 100 or the wireless communications system 200.

In some examples, as described herein, a SIB1 or other semi-static signaling may configure a second PRACH configuration that includes additional ROs that may be activated by the network entity 105 (e.g., via an activation signal such as a paging message). The network entity 105 may transmit activation signaling 705 (e.g., a PEI, a paging DCI, a paging PDSCH, or another DCI) that activates the second PRACH configuration for a time duration 715. For example, the time duration 715 may be in terms of a quantity of slots, a quantity of subframes, a quantity of frames, a quantity of association periods, a quantity of SSB-RO mapping cycles, a quantity of association pattern periods, or a quantity of ROs. The time duration may start a period of time 710 after the activation signaling 705 (e.g., with respect to a reference time based on the time interval during which the activation signaling 705 was received by the UE 115). In some examples, the period of time 710 may be zero (e.g., the second PRACH configuration may be immediately activated by the activation signaling 705).

In some examples, before the end of the time duration 715 and after the transmission/reception of the activation signaling 705, the network entity 105 may transmit second activation signaling 720 that activates the second PRACH configuration. In such examples, the UE 115 and the network entity 105 may determine the duration of the activation of the second PRACH configuration (e.g., the activation window 760) in accordance with a rule.

For example, as shown in the timing diagram 700, the rule may specify for the UE 115 and the network entity 105 to extend the activation window 760 by a time duration 725 equal to the time duration 715 (e.g., the duration of the activation window 760 may be doubled based on the reception of the second activation signaling 720).

As another example, as shown in the timing diagram 730, the rule may specify for the UE 115 and the network entity 105 to reset the activation window 760 based on the reception of the second activation signaling 720. For example, if the time duration is d, the activation window may extend for d after the second activation signaling 720 (e.g., the time duration 715 may be extended by the time duration 735).

As another example, as shown in the timing diagram 750, the UE 115 and the network entity 105 may not extend or reset the activation window (e.g., may terminate the activation of the second PRACH configuration at the end 755 of the time duration 715). In such examples, the activation window 760 may correspond to the time duration 715. For example, the network entity 105 may transmit the second activation signaling 720 to increase the probability that the UE 115 receives the activation signaling, but may not extend or reset the activation window 760 based on the second activation signaling 720.

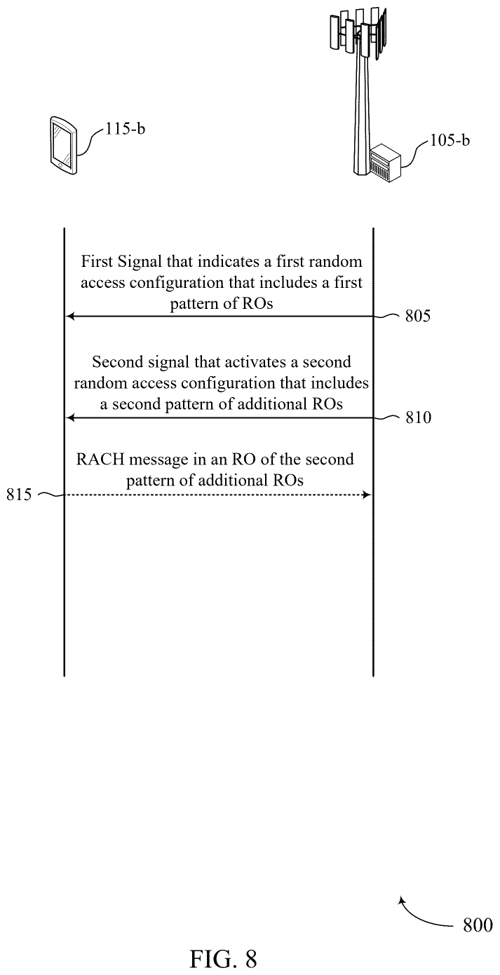

FIG. 8 shows an example of a process flow 800 that supports adaptation of random access configuration in wireless communications in accordance with one or more aspects of the present disclosure. The process flow 800 may implement or may be implemented by aspects of the wireless communications system 100 or the wireless communications system 200. For example, the process flow 800 may include a UE 115-b, which may be an example of a UE 115 as described herein. The process flow 800 may also include a network entity 105-b, which may be an example of a network entity 105 as described herein. In the following description of the process flow 800, the communications between the network entity 105-b and the UE 115-b may be transmitted in a different order than the example order shown, or the operations performed by the network entity 105-b and the UE 115-b may be performed in different orders or at different times. Some operations may also be omitted from the process flow 800, and other operations may be added to the process flow 800.

At 805, the network entity 105-b may transmit, and the UE 115-b may receive, a first signal that indicates a first random access configuration that includes a first pattern of first random access occasions (e.g., first ROs) available during a random access configuration period. For example, the first signal may be a SIB1 or other SI or RRC signaling.

At 810, the network entity 105-b may transmit, and the UE 115-b may receive, within a time interval during the random access configuration period, a second signal that activates a second random access configuration that includes a second pattern of additional random access occasions (e.g., additional ROs). Based on the second signal, at least a subset of additional random access occasions of the second pattern of additional random access occasions may be available for transmission by the UE for a time duration beginning at a start time. For example, the second signal may indicate that a subset of the additional random access occasions of the second pattern are available during the time duration (e.g., even number indexed random access occasions, odd number indexed random access occasions). As another example, the second signal may indicate that all of the random access occasions of the second pattern are available during the time duration. The start time may be based on a reference time which is based on the time interval. The second random access configuration may be activated for a time duration beginning at a start time. For example, the second signal may be an activation signal such as a PEI, a paging DCI, a paging PDSCH, or another DCI.

In some examples, at 815, the UE 115-b may transmit, and the network entity 105-b may receive, after the start time, a random access message in a random access occasion of the second pattern of additional random access occasions based on the second random access configuration. For example, the random access message may be a msg1 or a msgA.

In some examples, the time interval is a slot, and the reference time is one of a beginning time or an end time of the slot.

In some examples, the time interval is a frame, and the reference time is one of: a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

In some examples, the time interval is a paging cycle, and the reference time is one of: a beginning time or an end time of a temporally first slot within the paging cycle, a beginning time or an end time of a temporally last slot within the paging cycle, or a beginning time or an end time of a temporally first slot after the paging cycle.

In some examples, the start time is offset from the reference time by a quantity of association periods in accordance with the first random access configuration. For example, the quantity may be semi-statically configured via SIB1 or RRC configuration or indicated dynamically with the activation signaling (e.g., the second signal).

In some examples, the start time is offset from the reference time by a quantity of association periods in accordance with the second random access configuration. For example, the quantity may be semi-statically configured via SIB1 or RRC configuration or indicated dynamically with the activation signaling (e.g., the second signal).

In some examples, the start time is offset from the reference time by a quantity of PRACH configuration periods. For example, the quantity may be semi-statically configured via SIB1 or RRC configuration or indicated dynamically with the activation signaling (e.g., the second signal). In some examples, a respective duration of each PRACH configuration period of the quantity of PRACH configuration periods may be calculated using the first pattern of first random access occasions. In some examples, a respective duration of each PRACH configuration period of the quantity of PRACH configuration periods may be calculated using the second pattern of additional random access occasions. In some examples, a respective duration of each PRACH configuration period of the quantity of PRACH configuration periods may be calculated using both the first pattern of first random access occasions and the second pattern of additional random access occasions.

In some examples, the start time is offset from the reference time by a quantity of association pattern periods. For example, the quantity may be semi-statically configured via SIB1 or RRC configuration or indicated dynamically with the activation signaling (e.g., the second signal).

In some examples, the start time is offset from the reference time by a quantity of SSB to random access occasion mapping cycles associated with the first pattern of first random access occasions. For example, the quantity may be semi-statically configured via SIB1 or RRC configuration or indicated dynamically with the activation signaling (e.g., the second signal).

In some examples, the start time is offset from the reference time by a quantity of SSB to random access occasion mapping cycles associated with the second pattern of additional random access occasions. For example, the quantity may be semi-statically configured via SIB1 or RRC configuration or indicated dynamically with the activation signaling (e.g., the second signal).

In some examples, the network entity 105-b may transmit, and the UE 115-b may receive, after receipt of the second signal and before an end of the time duration, a third signal that activates the second random access configuration. For example, the third signal may be an activation signal such as a PEI, a paging DCI, a paging PDSCH, or another DCI. In some such examples, the UE 115-b and the network entity 105-b may reset, based on reception/transmission of the third signal, the time duration relative to a receipt time of the third signal. In some such examples, the UE 115-b and the network entity 105-b may extend, based on reception/transmission of the third signal, the time duration from an end time of the time duration by a second duration equal to the time duration. In some such examples, the UE 115-b and the network entity 105-b may terminate activation of the second random access configuration at an end of the time duration (e.g., may not extend or reset the time duration).

In some examples, the start time is common to all UEs 115 that receive an indication of the second random access configuration within the time interval, for example, even if the UEs 115 do not receive the indication at the same time.

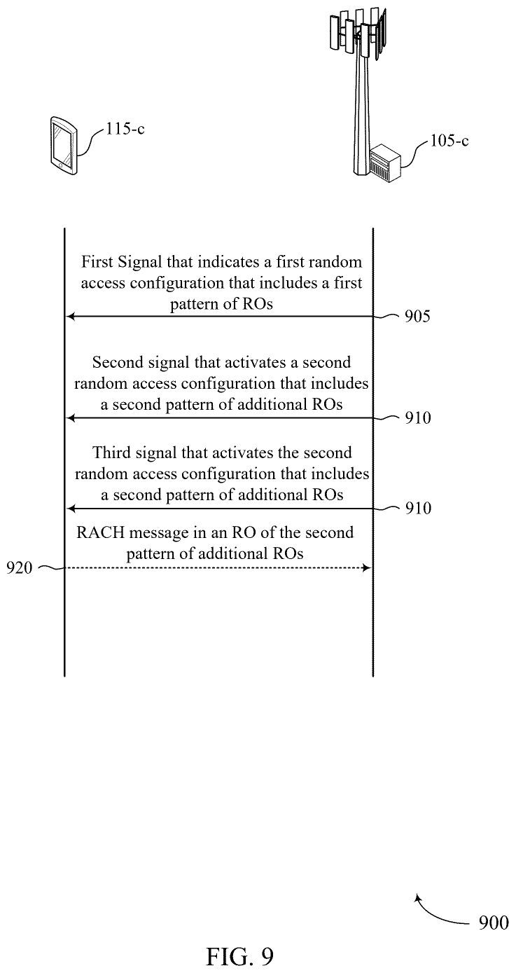

FIG. 9 shows an example of a process flow 900 that supports adaptation of random access configuration in wireless communications in accordance with one or more aspects of the present disclosure. The process flow 900 may implement or may be implemented by aspects of the wireless communications system 100 or the wireless communications system 200. For example, the process flow 900 may include a UE 115-c, which may be an example of a UE 115 as described herein. The process flow 900 may also include a network entity 105-c, which may be an example of a network entity 105 as described herein. In the following description of the process flow 900, the communications between the network entity 105-c and the UE 115-c may be transmitted in a different order than the example order shown, or the operations performed by the network entity 105-c and the UE 115-c may be performed in different orders or at different times. Some operations may also be omitted from the process flow 900, and other operations may be added to the process flow 900.

At 905, the network entity 105-c may transmit, and the UE 115-c may receive, a first signal that indicates a first random access configuration that includes a first pattern of first random access occasions (e.g., first ROs) available during a random access configuration period. For example, the first signal may be a SIB1 or other SI or RRC signaling.

At 910, the network entity 105-c may transmit, and the UE 115-c may receive, within a time interval during the random access configuration period, a second signal that activates a second random access configuration that includes a second pattern of additional random access occasions (e.g., additional ROs). At least a subset of additional random access occasions of the second pattern of additional random access occasions may be available for transmission for the UE for a time duration beginning at a start time. For example, the second signal may indicate that a subset of the additional random access occasions of the second pattern are available during the time duration (e.g., even number indexed random access occasions, odd number indexed random access occasions). As another example, the second signal may indicate that all of the random access occasions of the second pattern are available during the time duration. For example, the second signal may be an activation signal such as a PEI, a paging DCI, a paging PDSCH, or another DCI.

At 915, the network entity 105-c may transmit, and the UE 115-c may receive, after receipt of the second signal and before an end of the time duration, a third signal that activates the second random access configuration. For example, the third signal may be an activation signal such as a PEI, a paging DCI, a paging PDSCH, or another DCI.

At 920, the UE 115-c may transmit, and the network entity 105-c may receive, after receipt of the third signal, a random access message in a random access occasion of the second pattern of additional random access occasions based on the second random access configuration. Transmission of the random access message may be in accordance with a rule associated with receipt of the third signal after the receipt of the second signal and before the end of the time duration. For example, the random access message may be a msg1 or a msgA.

In some examples, the UE 115-c and the network entity 105-c may reset, in accordance with the rule, the time duration relative to a receipt time of the third signal.

In some examples, the UE 115-c and the network entity 105-c may extend, in accordance with the rule, the time duration from an end time of the time duration by a second duration equal to the time duration.

In some examples, the UE 115-c and the network entity 105-c may terminate, in accordance with the rule, activation of the second random access configuration at an end of the time duration (e.g., may not extend or reset the time duration).

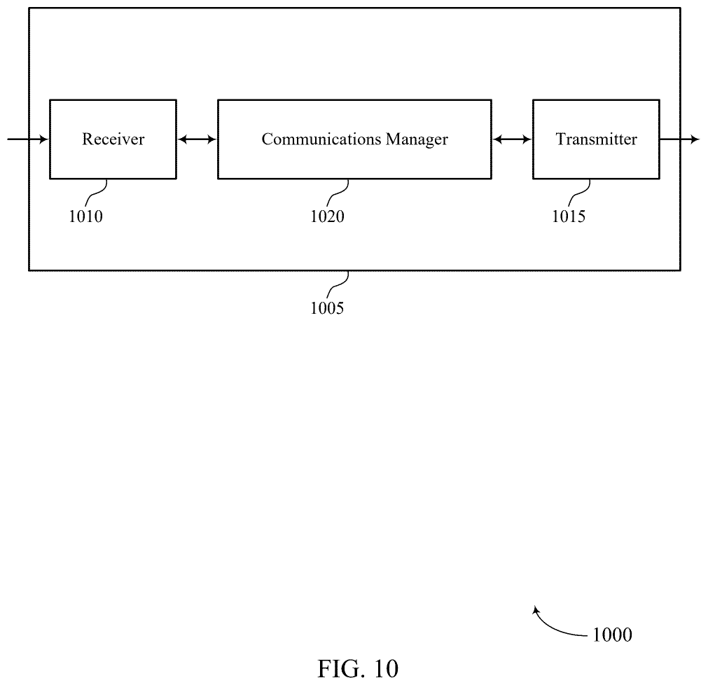

FIG. 10 shows a block diagram 1000 of a device 1005 that supports adaptation of random access configuration in wireless communications in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to adaptation of random access configuration in wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to adaptation of random access configuration in wireless communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of adaptation of random access configuration in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), a graphics processing unit (GPU) an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving a first signal that indicates a first random access configuration that includes a first pattern of first random access occasions available during a random access configuration period. The communications manager 1020 is capable of, configured to, or operable to support a means for receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The communications manager 1020 is capable of, configured to, or operable to support a means for transmitting, after the start time, a random access message in a random access occasion of the second pattern of additional random access occasions based on the second random access configuration.

Additionally, or alternatively, the communications manager 1020 may support wireless communications in accordance with examples as disclosed herein. For example, the communications manager 1020 is capable of, configured to, or operable to support a means for receiving a first signal that indicates a first random access configuration that includes a first pattern of first random access occasions available during a random access configuration period. The communications manager 1020 is capable of, configured to, or operable to support a means for receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time. The communications manager 1020 is capable of, configured to, or operable to support a means for receiving, after receipt of the second signal and before an end of the time duration, a third signal that activates the second random access configuration. The communications manager 1020 is capable of, configured to, or operable to support a means for transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced power consumption and more efficient utilization of communication resources.

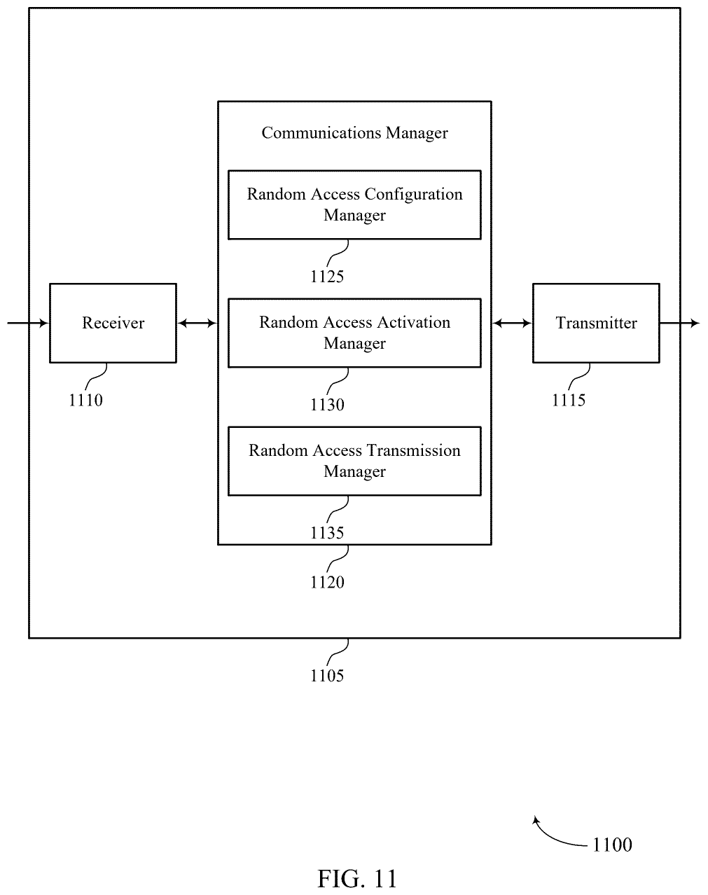

FIG. 11 shows a block diagram 1100 of a device 1105 that supports adaptation of random access configuration in wireless communications in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to adaptation of random access configuration in wireless communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to adaptation of random access configuration in wireless communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of adaptation of random access configuration in wireless communications as described herein. For example, the communications manager 1120 may include a random access configuration manager 1125, a random access activation manager 1130, a random access transmission manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The random access configuration manager 1125 is capable of, configured to, or operable to support a means for receiving a first signal that indicates a first random access configuration that includes a first pattern of first random access occasions available during a random access configuration period. The random access activation manager 1130 is capable of, configured to, or operable to support a means for receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The random access transmission manager 1135 is capable of, configured to, or operable to support a means for transmitting, after the start time, a random access message in a random access occasion of the second pattern of additional random access occasions based on the second random access configuration.

Additionally, or alternatively, the communications manager 1120 may support wireless communications in accordance with examples as disclosed herein. The random access configuration manager 1125 is capable of, configured to, or operable to support a means for receiving a first signal that indicates a first random access configuration that includes a first pattern of first random access occasions available during a random access configuration period. The random access activation manager 1130 is capable of, configured to, or operable to support a means for receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time. The random access activation manager 1130 is capable of, configured to, or operable to support a means for receiving, after receipt of the second signal and before an end of the time duration, a third signal that activates the second random access configuration. The random access transmission manager 1135 is capable of, configured to, or operable to support a means for transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

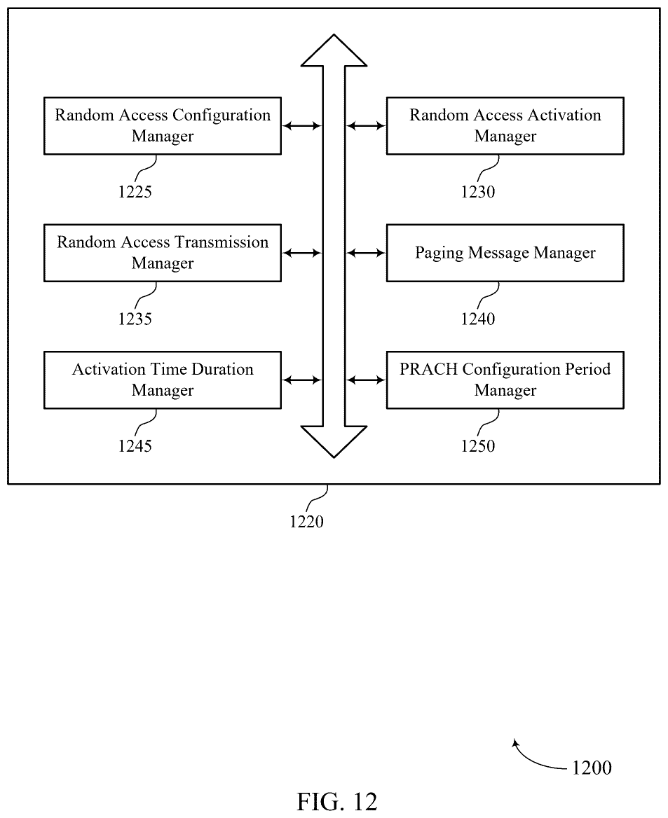

FIG. 12 shows a block diagram 1200 of a communications manager 1220 that supports adaptation of random access configuration in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of adaptation of random access configuration in wireless communications as described herein. For example, the communications manager 1220 may include a random access configuration manager 1225, a random access activation manager 1230, a random access transmission manager 1235, a paging message manager 1240, an activation time duration manager 1245, a PRACH configuration period manager 1250, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The random access configuration manager 1225 is capable of, configured to, or operable to support a means for receiving a first signal that indicates a first random access configuration that includes a first pattern of first random access occasions available during a random access configuration period. The random access activation manager 1230 is capable of, configured to, or operable to support a means for receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The random access transmission manager 1235 is capable of, configured to, or operable to support a means for transmitting, after the start time, a random access message in a random access occasion of the second pattern of additional random access occasions based on the second random access configuration.

In some examples, the time interval is a slot. In some examples, the reference time is one of a beginning time or an end time of the slot.

In some examples, the time interval is a frame, and the reference time is one of: a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

In some examples, to support receiving the second signal, the paging message manager 1240 is capable of, configured to, or operable to support a means for receiving the second signal via a paging message during a paging cycle, where the time interval is the paging cycle, and where the reference time is one of: a beginning time or an end time of a temporally first slot within the paging cycle, a beginning time or an end time of a temporally last slot within the paging cycle, or a beginning time or an end time of a temporally first slot after the paging cycle.

In some examples, the start time is offset from the reference time by a quantity of association periods in accordance with the first random access configuration.

In some examples, the start time is offset from the reference time by a quantity of association periods in accordance with the second random access configuration.

In some examples, the start time is offset from the reference time by a quantity of PRACH configuration periods.

In some examples, the PRACH configuration period manager 1250 is capable of, configured to, or operable to support a means for calculating a respective duration of each PRACH configuration period of the quantity of PRACH configuration periods using the first pattern of first random access occasions.

In some examples, the PRACH configuration period manager 1250 is capable of, configured to, or operable to support a means for calculating a respective duration of each PRACH configuration period of the quantity of PRACH configuration periods using the second pattern of additional random access occasions.

In some examples, the PRACH configuration period manager 1250 is capable of, configured to, or operable to support a means for calculating a respective duration of each PRACH configuration period of the quantity of PRACH configuration periods using both the first pattern of first random access occasions and the second pattern of additional random access occasions.

In some examples, the start time is offset from the reference time by a quantity of association pattern periods.

In some examples, the start time is offset from the reference time by a quantity of SSB to random access occasion mapping cycles associated with the first pattern of first random access occasions.

In some examples, the start time is offset from the reference time by a quantity of SSB to random access occasion mapping cycles associated with the second pattern of additional random access occasions.

In some examples, the random access activation manager 1230 is capable of, configured to, or operable to support a means for receiving, after receipt of the second signal and before an end of the time duration, a third signal that activates the second random access configuration. In some examples, the activation time duration manager 1245 is capable of, configured to, or operable to support a means for resetting, based on reception of the third signal, the time duration relative to a receipt time of the third signal.

In some examples, the random access activation manager 1230 is capable of, configured to, or operable to support a means for receiving, after receipt of the second signal and before an end of the time duration, a third signal that activates the second random access configuration. In some examples, the activation time duration manager 1245 is capable of, configured to, or operable to support a means for terminating activation of the second random access configuration at an end of the time duration.

In some examples, the random access activation manager 1230 is capable of, configured to, or operable to support a means for receiving, after receipt of the second signal and before an end of the time duration, a third signal that activates the second random access configuration. In some examples, the activation time duration manager 1245 is capable of, configured to, or operable to support a means for extending, based on reception of the third signal, the time duration from an end time of the time duration by a second duration equal to the time duration.

In some examples, the start time is common to all UEs that receive an indication of the second random access configuration within the time interval.

Additionally, or alternatively, the communications manager 1220 may support wireless communications in accordance with examples as disclosed herein. In some examples, the random access configuration manager 1225 is capable of, configured to, or operable to support a means for receiving a first signal that indicates a first random access configuration that includes a first pattern of first random access occasions available during a random access configuration period. In some examples, the random access activation manager 1230 is capable of, configured to, or operable to support a means for receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time. In some examples, the random access activation manager 1230 is capable of, configured to, or operable to support a means for receiving, after receipt of the second signal and before an end of the time duration, a third signal that activates the second random access configuration. In some examples, the random access transmission manager 1235 is capable of, configured to, or operable to support a means for transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

In some examples, the activation time duration manager 1245 is capable of, configured to, or operable to support a means for resetting, in accordance with the rule, the time duration relative to a receipt time of the third signal.

In some examples, the activation time duration manager 1245 is capable of, configured to, or operable to support a means for terminating, in accordance with the rule, activation of the second random access configuration at an end of the time duration.

In some examples, the activation time duration manager 1245 is capable of, configured to, or operable to support a means for extending, in accordance with the rule, the time duration from an end time of the time duration by a second duration equal to the time duration.

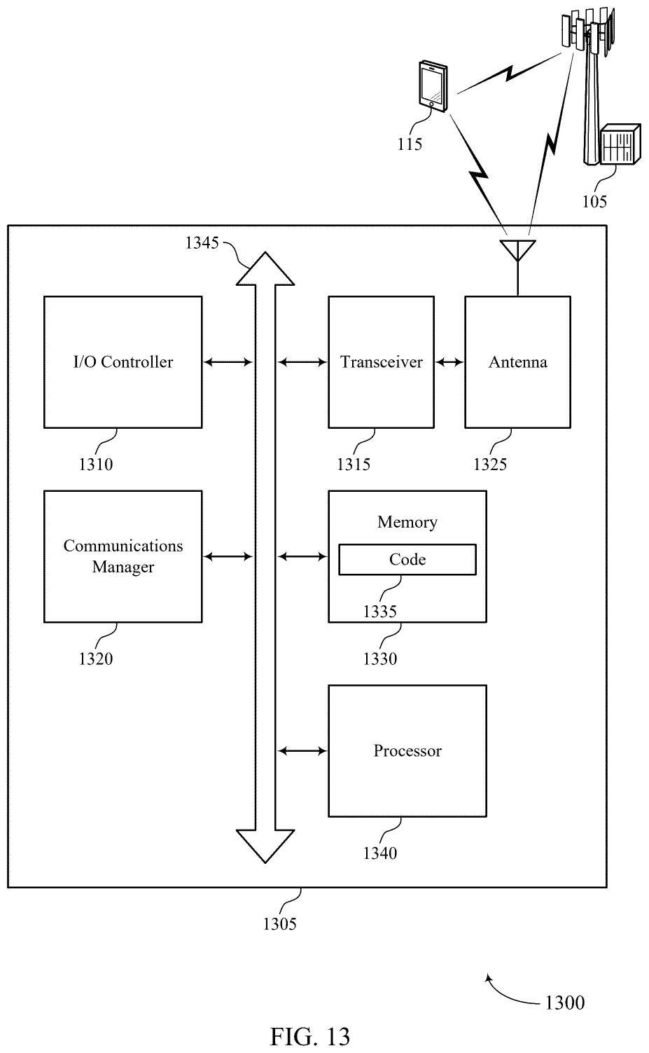

FIG. 13 shows a diagram of a system 1300 including a device 1305 that supports adaptation of random access configuration in wireless communications in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more GPUs, one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting adaptation of random access configuration in wireless communications). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for receiving a first signal that indicates a first random access configuration that includes a first pattern of first random access occasions available during a random access configuration period. The communications manager 1320 is capable of, configured to, or operable to support a means for receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The communications manager 1320 is capable of, configured to, or operable to support a means for transmitting, after the start time, a random access message in a random access occasion of the second pattern of additional random access occasions based on the second random access configuration.

Additionally, or alternatively, the communications manager 1320 may support wireless communications in accordance with examples as disclosed herein. For example, the communications manager 1320 is capable of, configured to, or operable to support a means for receiving a first signal that indicates a first random access configuration that includes a first pattern of first random access occasions available during a random access configuration period. The communications manager 1320 is capable of, configured to, or operable to support a means for receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time. The communications manager 1320 is capable of, configured to, or operable to support a means for receiving, after receipt of the second signal and before an end of the time duration, a third signal that activates the second random access configuration. The communications manager 1320 is capable of, configured to, or operable to support a means for transmitting, after receipt of the third signal, a random access message in a random access occasion of the second pattern of additional random access occasions based on the second random access configuration, where transmission of the random access message is in accordance with a rule associated with receipt of the third signal after the receipt of the second signal and before the end of the time duration.

By including or configuring the communications manager 1320 in accordance with examples as described herein, the device 1305 may support techniques for improved communication reliability, reduced latency, reduced power consumption, more efficient utilization of communication resources, improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of adaptation of random access configuration in wireless communications as described herein, or the at least one processor 1340 and the at least one memory 1330 may be otherwise configured to, individually or collectively, perform or support such operations.

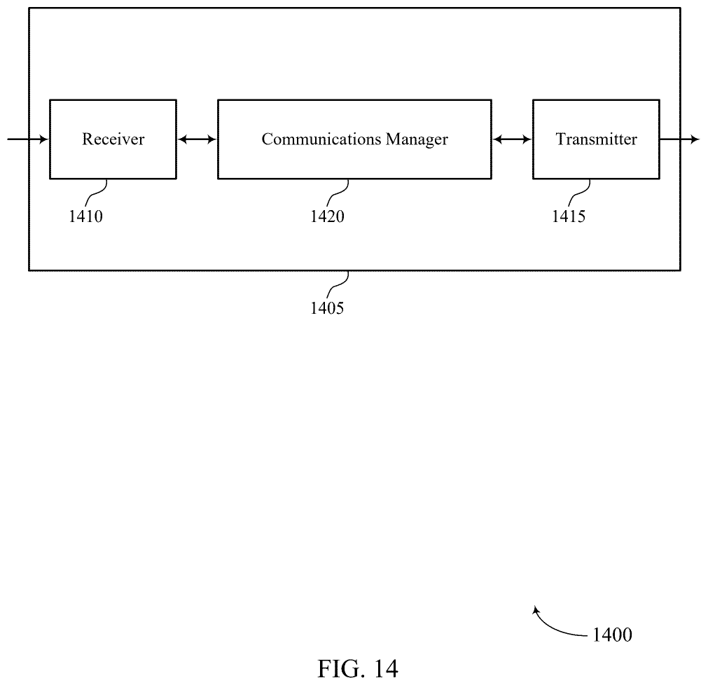

FIG. 14 shows a block diagram 1400 of a device 1405 that supports adaptation of random access configuration in wireless communications in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations or components thereof may be examples of means for performing various aspects of adaptation of random access configuration in wireless communications as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. For example, the communications manager 1420 is capable of, configured to, or operable to support a means for outputting a first signal that indicates a first random access configuration that includes a first pattern of first random access occasions available during a random access configuration period. The communications manager 1420 is capable of, configured to, or operable to support a means for outputting, for one or more user equipment (UEs) and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The communications manager 1420 is capable of, configured to, or operable to support a means for obtaining, from at least one of the one or more UEs and after the start time, a random access message in a random access occasion of the second pattern of additional random access occasions based on the second random access configuration.

Additionally, or alternatively, the communications manager 1420 may support wireless communications in accordance with examples as disclosed herein. For example, the communications manager 1420 is capable of, configured to, or operable to support a means for outputting a first signal that indicates a first random access configuration that includes a first pattern of first random access occasions available during a random access configuration period. The communications manager 1420 is capable of, configured to, or operable to support a means for outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time. The communications manager 1420 is capable of, configured to, or operable to support a means for outputting, to the one or more UEs after output of the second signal and before an end of the time duration, a third signal that activates the second random access configuration. The communications manager 1420 is capable of, configured to, or operable to support a means for obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for reduced power consumption and more efficient utilization of communication resources.

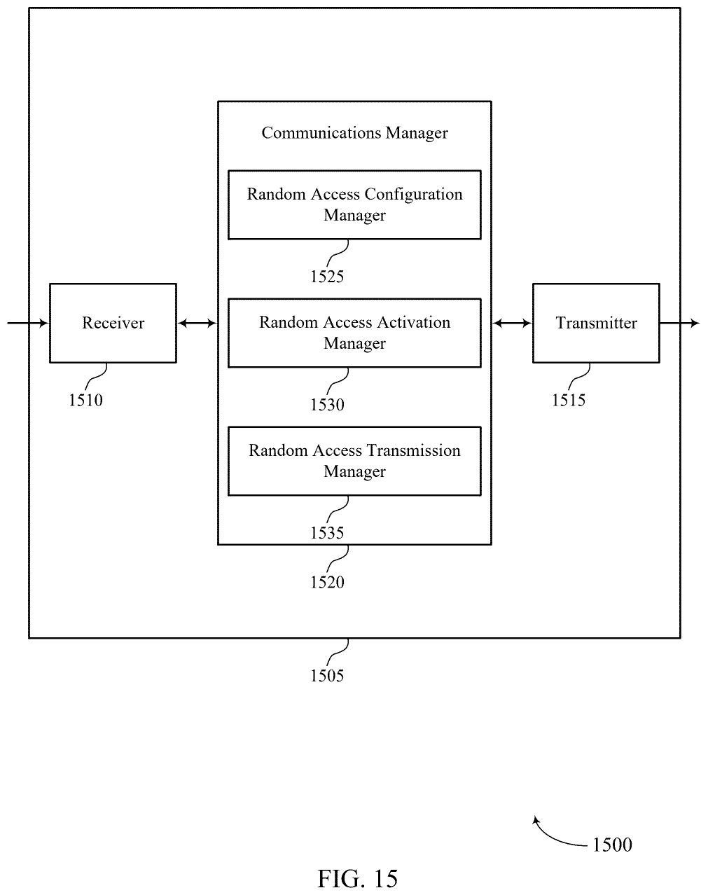

FIG. 15 shows a block diagram 1500 of a device 1505 that supports adaptation of random access configuration in wireless communications in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of adaptation of random access configuration in wireless communications as described herein. For example, the communications manager 1520 may include a random access configuration manager 1525, a random access activation manager 1530, a random access transmission manager 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. The random access configuration manager 1525 is capable of, configured to, or operable to support a means for outputting a first signal that indicates a first random access configuration that includes a first pattern of first random access occasions available during a random access configuration period. The random access activation manager 1530 is capable of, configured to, or operable to support a means for outputting, for one or more user equipment (UEs) and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The random access transmission manager 1535 is capable of, configured to, or operable to support a means for obtaining, from at least one of the one or more UEs and after the start time, a random access message in a random access occasion of the second pattern of additional random access occasions based on the second random access configuration.

Additionally, or alternatively, the communications manager 1520 may support wireless communications in accordance with examples as disclosed herein. The random access configuration manager 1525 is capable of, configured to, or operable to support a means for outputting a first signal that indicates a first random access configuration that includes a first pattern of first random access occasions available during a random access configuration period. The random access activation manager 1530 is capable of, configured to, or operable to support a means for outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time. The random access activation manager 1530 is capable of, configured to, or operable to support a means for outputting, to the one or more UEs after output of the second signal and before an end of the time duration, a third signal that activates the second random access configuration. The random access transmission manager 1535 is capable of, configured to, or operable to support a means for obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

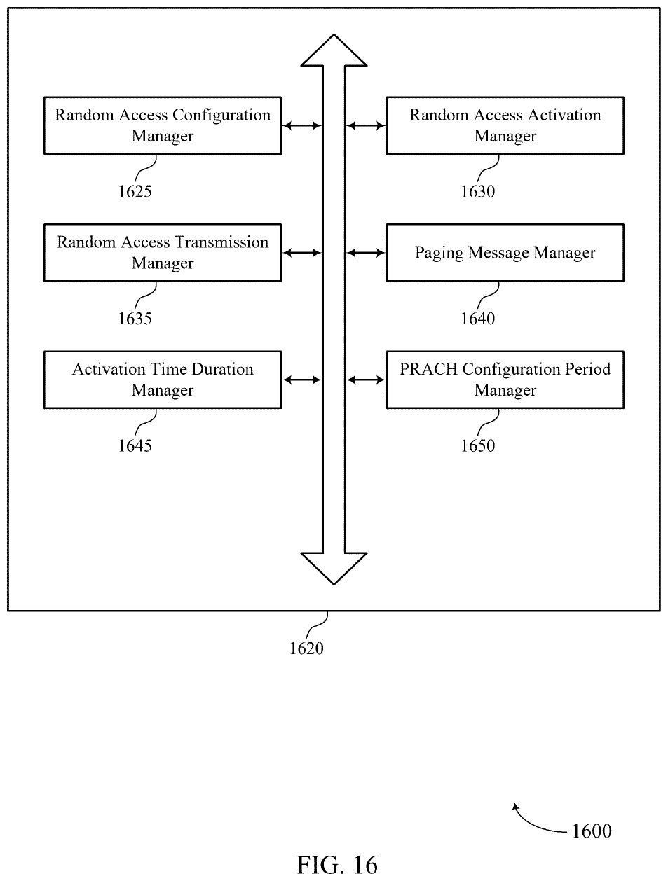

FIG. 16 shows a block diagram 1600 of a communications manager 1620 that supports adaptation of random access configuration in wireless communications in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of adaptation of random access configuration in wireless communications as described herein. For example, the communications manager 1620 may include a random access configuration manager 1625, a random access activation manager 1630, a random access transmission manager 1635, a paging message manager 1640, an activation time duration manager 1645, a PRACH configuration period manager 1650, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications in accordance with examples as disclosed herein. The random access configuration manager 1625 is capable of, configured to, or operable to support a means for outputting a first signal that indicates a first random access configuration that includes a first pattern of first random access occasions available during a random access configuration period. The random access activation manager 1630 is capable of, configured to, or operable to support a means for outputting, for one or more user equipment (UEs) and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The random access transmission manager 1635 is capable of, configured to, or operable to support a means for obtaining, from at least one of the one or more UEs and after the start time, a random access message in a random access occasion of the second pattern of additional random access occasions based on the second random access configuration.

In some examples, the time interval is a slot. In some examples, the reference time is one of a beginning time or an end time of the slot.

In some examples, the time interval is a frame, and the reference time is one of: a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

In some examples, to support outputting the second signal, the paging message manager 1640 is capable of, configured to, or operable to support a means for outputting the second signal via a paging message during a paging cycle, where the time interval is the paging cycle, and where the reference time is one of: a beginning time or an end time of a temporally first slot within the paging cycle, a beginning time or an end time of a temporally last slot within the paging cycle, or a beginning time or an end time of a temporally first slot after the paging cycle.

In some examples, the start time is offset from the reference time by a quantity of association periods in accordance with the first random access configuration.

In some examples, the start time is offset from the reference time by a quantity of association periods in accordance with the second random access configuration.

In some examples, the start time is offset from the reference time by a quantity of PRACH configuration periods.

In some examples, the PRACH configuration period manager 1650 is capable of, configured to, or operable to support a means for calculating a respective duration of each PRACH configuration period of the quantity of PRACH configuration periods using the first pattern of first random access occasions.

In some examples, the PRACH configuration period manager 1650 is capable of, configured to, or operable to support a means for calculating a respective duration of each PRACH configuration period of the quantity of PRACH configuration periods using the second pattern of additional random access occasions.

In some examples, the PRACH configuration period manager 1650 is capable of, configured to, or operable to support a means for calculating a respective duration of each PRACH configuration period of the quantity of PRACH configuration periods using both the first pattern of first random access occasions and the second pattern of additional random access occasions.

In some examples, the start time is offset from the reference time by a quantity of association pattern periods.

In some examples, the start time is offset from the reference time by a quantity of SSB to random access occasion mapping cycles associated with the first pattern of first random access occasions.

In some examples, the start time is offset from the reference time by a quantity of SSB to random access occasion mapping cycles associated with the second pattern of additional random access occasions.

In some examples, the random access activation manager 1630 is capable of, configured to, or operable to support a means for outputting, after output of the second signal and before an end of the time duration, a third signal that activates the second random access configuration. In some examples, the activation time duration manager 1645 is capable of, configured to, or operable to support a means for resetting, based on output of the third signal, the time duration relative to a receipt time of the third signal.

In some examples, the random access activation manager 1630 is capable of, configured to, or operable to support a means for outputting, after output of the second signal and before an end of the time duration, a third signal that activates the second random access configuration. In some examples, the activation time duration manager 1645 is capable of, configured to, or operable to support a means for terminating activation of the second random access configuration at an end of the time duration.

In some examples, the random access activation manager 1630 is capable of, configured to, or operable to support a means for outputting, after output of the second signal and before an end of the time duration, a third signal that activates the second random access configuration. In some examples, the activation time duration manager 1645 is capable of, configured to, or operable to support a means for extending, based on reception of the third signal, the time duration from an end time of the time duration by a second duration equal to the time duration.

In some examples, the random access activation manager 1630 is capable of, configured to, or operable to support a means for transmitting, within the time interval to one or more second UEs, one or more respective second signals that indicate the second random access configuration, where the start time is common to the one or more UEs and the one or more second UEs.

Additionally, or alternatively, the communications manager 1620 may support wireless communications in accordance with examples as disclosed herein. In some examples, the random access configuration manager 1625 is capable of, configured to, or operable to support a means for outputting a first signal that indicates a first random access configuration that includes a first pattern of first random access occasions available during a random access configuration period. In some examples, the random access activation manager 1630 is capable of, configured to, or operable to support a means for outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time. In some examples, the random access activation manager 1630 is capable of, configured to, or operable to support a means for outputting, to the one or more UEs after output of the second signal and before an end of the time duration, a third signal that activates the second random access configuration. In some examples, the random access transmission manager 1635 is capable of, configured to, or operable to support a means for obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

In some examples, the activation time duration manager 1645 is capable of, configured to, or operable to support a means for resetting, in accordance with the rule, the time duration relative to a receipt time of the third signal.

In some examples, the activation time duration manager 1645 is capable of, configured to, or operable to support a means for terminating, in accordance with the rule, activation of the second random access configuration at an end of the time duration.

In some examples, the activation time duration manager 1645 is capable of, configured to, or operable to support a means for extending, in accordance with the rule, the time duration from an end time of the time duration by a second duration equal to the time duration.

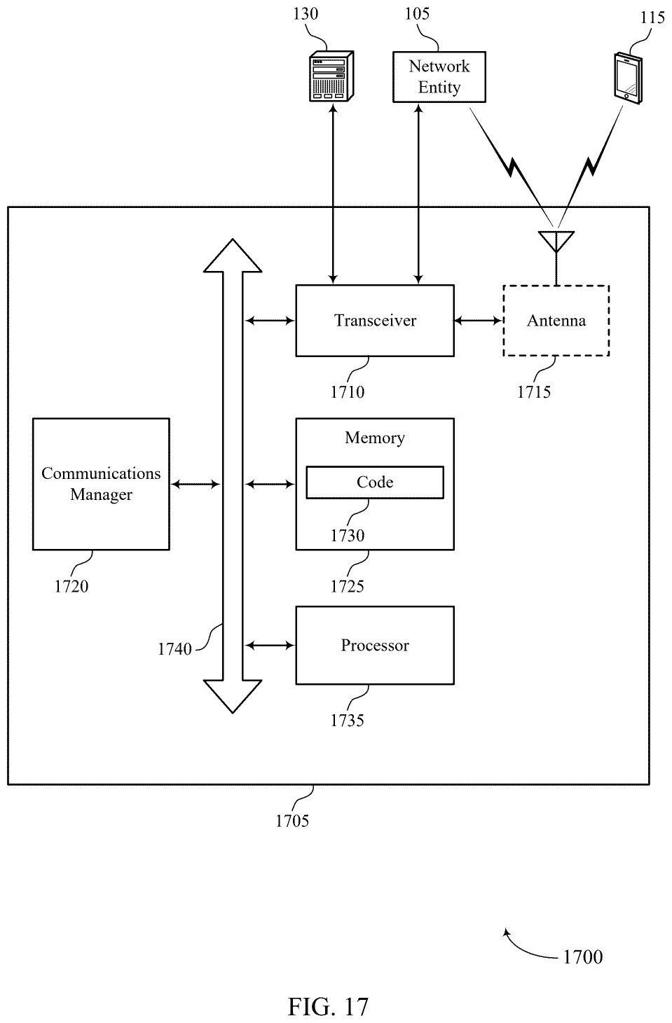

FIG. 17 shows a diagram of a system 1700 including a device 1705 that supports adaptation of random access configuration in wireless communications in accordance with one or more aspects of the present disclosure. The device 1705 may be an example of or include components of a device 1405, a device 1505, or a network entity 105 as described herein. The device 1705 may communicate with other network devices or network equipment such as one or more of the network entities 105, UEs 115, or any combination thereof. The communications may include communications over one or more wired interfaces, over one or more wireless interfaces, or any combination thereof. The device 1705 may include components that support outputting and obtaining communications, such as a communications manager 1720, a transceiver 1710, one or more antennas 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., communication link(s) 125, backhaul communication link(s) 120, a midhaul communication link 162, a fronthaul communication link 168).

The at least one memory 1725 may include RAM, ROM, or any combination thereof. The at least one memory 1725 may store computer-readable, computer-executable, or processor-executable code, such as the code 1730. The code 1730 may include instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may include, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting adaptation of random access configuration in wireless communications). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725).

In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with one or more other network entities 105, and may include a controller or scheduler for controlling communications with UEs 115 (e.g., in cooperation with the one or more other network devices). In some examples, the communications manager 1720 may support an X2 interface within an LTE/LTE-A wireless communications network technology to provide communication between network entities 105.

The communications manager 1720 may support wireless communications in accordance with examples as disclosed herein. For example, the communications manager 1720 is capable of, configured to, or operable to support a means for outputting a first signal that indicates a first random access configuration that includes a first pattern of first random access occasions available during a random access configuration period. The communications manager 1720 is capable of, configured to, or operable to support a means for outputting, for one or more user equipment (UEs) and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based on the time interval. The communications manager 1720 is capable of, configured to, or operable to support a means for obtaining, from at least one of the one or more UEs and after the start time, a random access message in a random access occasion of the second pattern of additional random access occasions based on the second random access configuration.

Additionally, or alternatively, the communications manager 1720 may support wireless communications in accordance with examples as disclosed herein. For example, the communications manager 1720 is capable of, configured to, or operable to support a means for outputting a first signal that indicates a first random access configuration that includes a first pattern of first random access occasions available during a random access configuration period. The communications manager 1720 is capable of, configured to, or operable to support a means for outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time. The communications manager 1720 is capable of, configured to, or operable to support a means for outputting, to the one or more UEs after output of the second signal and before an end of the time duration, a third signal that activates the second random access configuration. The communications manager 1720 is capable of, configured to, or operable to support a means for obtaining, from at least one UE of the one or more UEs and after output of the third signal, a random access message in a random access occasion of the second pattern of additional random access occasions based on the second random access configuration, where the random access message is obtained in accordance with a rule associated with the output of the third signal after the output of the second signal and before the end of the time duration.

By including or configuring the communications manager 1720 in accordance with examples as described herein, the device 1705 may support techniques for improved communication reliability, reduced latency, reduced power consumption, more efficient utilization of communication resources, improved coordination between devices.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of adaptation of random access configuration in wireless communications as described herein, or the at least one processor 1735 and the at least one memory 1725 may be otherwise configured to, individually or collectively, perform or support such operations.

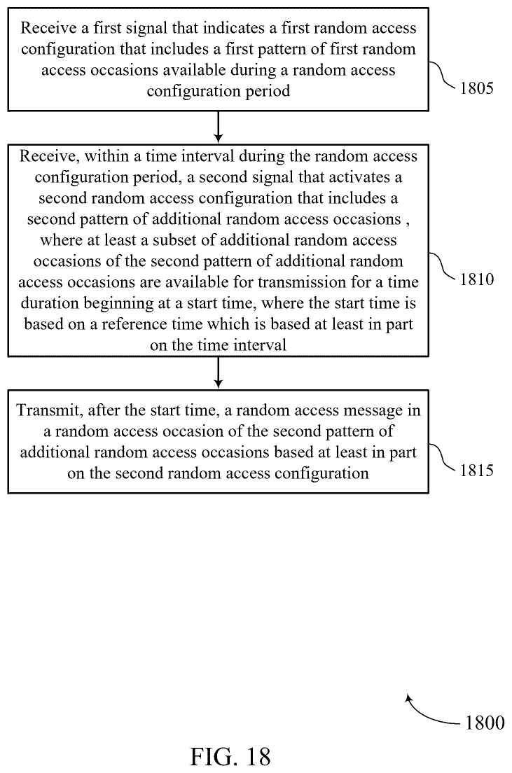

FIG. 18 shows a flowchart illustrating a method 1800 that supports adaptation of random access configuration in wireless communications in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving a first signal that indicates a first random access configuration that includes a first pattern of first random access occasions available during a random access configuration period. The operations of 1805 may be performed in accordance with examples as disclosed herein. In some examples, aspects of the operations of 1805 may be performed by a random access configuration manager 1225 as described with reference to FIG. 12.

At 1810, the method may include receiving, within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based at least in part on the time interval. The operations of 1810 may be performed in accordance with examples as disclosed herein. In some examples, aspects of the operations of 1810 may be performed by a random access activation manager 1230 as described with reference to FIG. 12.

At 1815, the method may include transmitting, after the start time, a random access message in a random access occasion of the second pattern of additional random access occasions based at least in part on the second random access configuration. The operations of 1815 may be performed in accordance with examples as disclosed herein. In some examples, aspects of the operations of 1815 may be performed by a random access transmission manager 1235 as described with reference to FIG. 12.

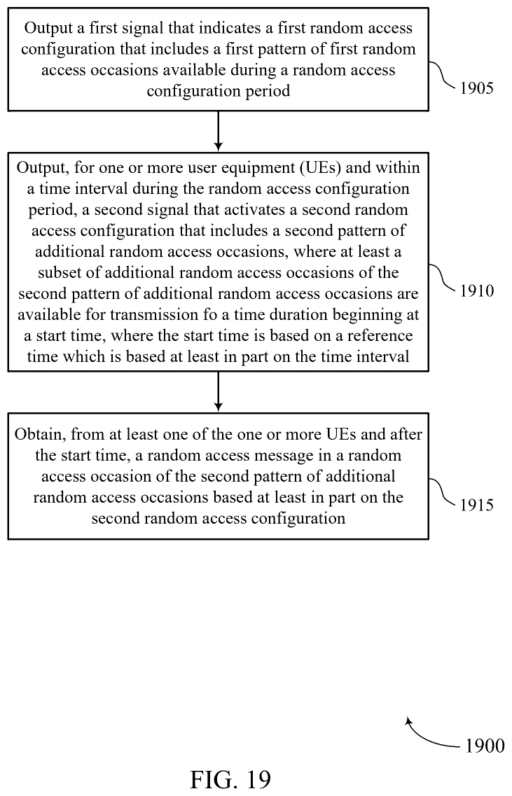

FIG. 19 shows a flowchart illustrating a method 1900 that supports adaptation of random access configuration in wireless communications in accordance with one or more aspects of the present disclosure. The operations of the method 1900 may be implemented by a network entity or its components as described herein. For example, the operations of the method 1900 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 1905, the method may include outputting a first signal that indicates a first random access configuration that includes a first pattern of first random access occasions available during a random access configuration period. The operations of 1905 may be performed in accordance with examples as disclosed herein. In some examples, aspects of the operations of 1905 may be performed by a random access configuration manager 1625 as described with reference to FIG. 16.

At 1910, the method may include outputting, for one or more user equipment (UEs) and within a time interval during the random access configuration period, a second signal that activates a second random access configuration that includes a second pattern of additional random access occasions, where at least a subset of additional random access occasions of the second pattern of additional random access occasions are available for transmission for a time duration beginning at a start time, where the start time is based on a reference time which is based at least in part on the time interval. The operations of 1910 may be performed in accordance with examples as disclosed herein. In some examples, aspects of the operations of 1910 may be performed by a random access activation manager 1630 as described with reference to FIG. 16.

At 1915, the method may include obtaining, from at least one of the one or more UEs and after the start time, a random access message in a random access occasion of the second pattern of additional random access occasions based at least in part on the second random access configuration. The operations of 1915 may be performed in accordance with examples as disclosed herein. In some examples, aspects of the operations of 1915 may be performed by a random access transmission manager 1635 as described with reference to FIG. 16.

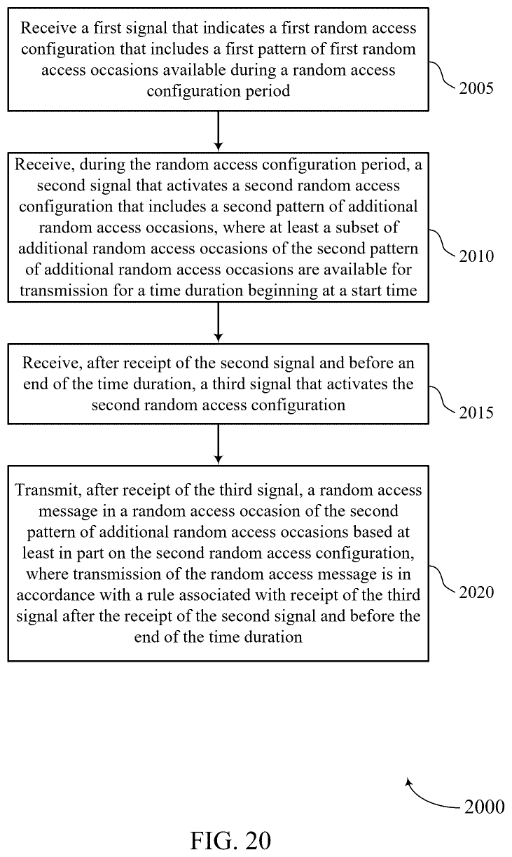

FIG. 20 shows a flowchart illustrating a method 2000 that supports adaptation of random access configuration in wireless communications in accordance with one or more aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2005, the method may include receiving a first signal that indicates a first random access configuration that includes a first pattern of first random access occasions available during a random access configuration period. The operations of 2005 may be performed in accordance with examples as disclosed herein. In some examples, aspects of the operations of 2005 may be performed by a random access configuration manager 1225 as described with reference to FIG. 12.

At 2010, the method may include receiving, during the random access configuration period, a second signal that activates a second random access configuration that includes a second pattern of additional random access occasions, where at least a subset of additional random access occasions of the second pattern of additional random access occasions are available for transmission for a time duration beginning at a start time. The operations of 2010 may be performed in accordance with examples as disclosed herein. In some examples, aspects of the operations of 2010 may be performed by a random access activation manager 1230 as described with reference to FIG. 12.

At 2015, the method may include receiving, after receipt of the second signal and before an end of the time duration, a third signal that activates the second random access configuration. The operations of 2015 may be performed in accordance with examples as disclosed herein. In some examples, aspects of the operations of 2015 may be performed by a random access activation manager 1230 as described with reference to FIG. 12.

At 2020, the method may include transmitting, after receipt of the third signal, a random access message in a random access occasion of the second pattern of additional random access occasions based at least in part on the second random access configuration, where transmission of the random access message is in accordance with a rule associated with receipt of the third signal after the receipt of the second signal and before the end of the time duration. The operations of 2020 may be performed in accordance with examples as disclosed herein. In some examples, aspects of the operations of 2020 may be performed by a random access transmission manager 1235 as described with reference to FIG. 12.

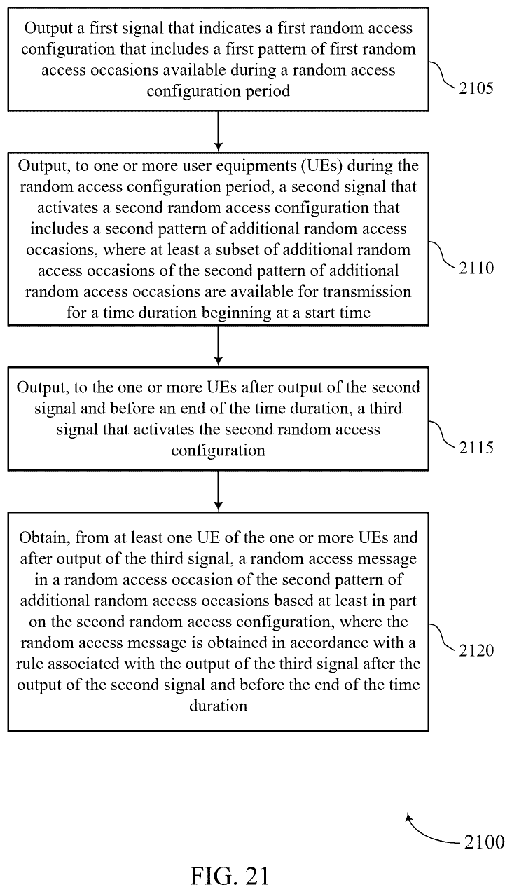

FIG. 21 shows a flowchart illustrating a method 2100 that supports adaptation of random access configuration in wireless communications in accordance with one or more aspects of the present disclosure. The operations of the method 2100 may be implemented by a network entity or its components as described herein. For example, the operations of the method 2100 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include outputting a first signal that indicates a first random access configuration that includes a first pattern of first random access occasions available during a random access configuration period. The operations of 2105 may be performed in accordance with examples as disclosed herein. In some examples, aspects of the operations of 2105 may be performed by a random access configuration manager 1625 as described with reference to FIG. 16.

At 2110, the method may include outputting, to one or more user equipments (UEs) during the random access configuration period, a second signal that activates a second random access configuration that includes a second pattern of additional random access occasions, where at least a subset of additional random access occasions of the second pattern of additional random access occasions are available for transmission for a time duration beginning at a start time. The operations of 2110 may be performed in accordance with examples as disclosed herein. In some examples, aspects of the operations of 2110 may be performed by a random access activation manager 1630 as described with reference to FIG. 16.

At 2115, the method may include outputting, to the one or more UEs after output of the second signal and before an end of the time duration, a third signal that activates the second random access configuration. The operations of 2115 may be performed in accordance with examples as disclosed herein. In some examples, aspects of the operations of 2115 may be performed by a random access activation manager 1630 as described with reference to FIG. 16.

At 2120, the method may include obtaining, from at least one UE of the one or more UEs and after output of the third signal, a random access message in a random access occasion of the second pattern of additional random access occasions based at least in part on the second random access configuration, where the random access message is obtained in accordance with a rule associated with the output of the third signal after the output of the second signal and before the end of the time duration. The operations of 2120 may be performed in accordance with examples as disclosed herein. In some examples, aspects of the operations of 2120 may be performed by a random access transmission manager 1635 as described with reference to FIG. 16.

The following provides an overview of aspects of the present disclosure:

Aspect 1: A method for wireless communications at a UE, comprising: receiving a first signal that indicates a first random access configuration that includes a first pattern of first random access occasions available during a random access configuration period; receiving, within a time interval during the random access configuration period, a second signal that activates a second random access configuration that includes a second pattern of additional random access occasions, wherein at least a subset of additional random access occasions of the second pattern of additional random access occasions are available for transmission for a time duration beginning at a start time, wherein the start time is based on a reference time which is based at least in part on the time interval; and transmitting, after the start time, a random access message in a random access occasion of the second pattern of additional random access occasions based at least in part on the second random access configuration.

Aspect 2: The method of aspect 1, wherein the time interval is a slot, and the reference time is one of a beginning time or an end time of the slot.

Aspect 3: The method of aspect 1, wherein the time interval is a frame, and wherein the reference time is one of a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

Aspect 4: The method of aspect 1, wherein receiving the second signal comprises: receiving the second signal via a paging message during a paging cycle, wherein the time interval is the paging cycle, and wherein the reference time is one of: a beginning time or an end time of a temporally first slot within the paging cycle, a beginning time or an end time of a temporally last slot within the paging cycle, or a beginning time or an end time of a temporally first slot after the paging cycle.

Aspect 5: The method of any of aspects 1 through 4, wherein the start time is offset from the reference time by a quantity of association periods in accordance with the first random access configuration.

Aspect 6: The method of any of aspects 1 through 5, wherein the start time is offset from the reference time by a quantity of association periods in accordance with the second random access configuration.

Aspect 7: The method of any of aspects 1 through 6, wherein the start time is offset from the reference time by a quantity of PRACH configuration periods.

Aspect 8: The method of aspect 7, further comprising: calculating a respective duration of each PRACH configuration period of the quantity of PRACH configuration periods using the first pattern of first random access occasions.

Aspect 9: The method of any of aspects 7 through 8, further comprising: calculating a respective duration of each PRACH configuration period of the quantity of PRACH configuration periods using the second pattern of additional random access occasions.

Aspect 10: The method of any of aspects 7 through 9, further comprising: calculating a respective duration of each PRACH configuration period of the quantity of PRACH configuration periods using both the first pattern of first random access occasions and the second pattern of additional random access occasions.

Aspect 11: The method of any of aspects 1 through 10, wherein the start time is offset from the reference time by a quantity of association pattern periods.

Aspect 12: The method of any of aspects 1 through 11, wherein the start time is offset from the reference time by a quantity of SSB to random access occasion mapping cycles associated with the first pattern of first random access occasions.

Aspect 13: The method of any of aspects 1 through 12, wherein the start time is offset from the reference time by a quantity of SSB to random access occasion mapping cycles associated with the second pattern of additional random access occasions.

Aspect 14: The method of any of aspects 1 through 13, further comprising: receiving, after receipt of the second signal and before an end of the time duration, a third signal that activates the second random access configuration; and resetting, based at least in part on reception of the third signal, the time duration relative to a receipt time of the third signal.

Aspect 15: The method of any of aspects 1 through 13, further comprising: receiving, after receipt of the second signal and before an end of the time duration, a third signal that activates the second random access configuration; and terminating activation of the second random access configuration at an end of the time duration.

Aspect 16: The method of any of aspects 1 through 13, further comprising: receiving, after receipt of the second signal and before an end of the time duration, a third signal that activates the second random access configuration; and extending, based at least in part on reception of the third signal, the time duration from an end time of the time duration by a second duration equal to the time duration.

Aspect 17: The method of any of aspects 1 through 13, wherein the start time is common to all UEs that receive an indication of the second random access configuration within the time interval.

Aspect 18: A method for wireless communications at a network entity, comprising: outputting a first signal that indicates a first random access configuration that includes a first pattern of first random access occasions available during a random access configuration period; outputting, for one or more user equipment (UEs) and within a time interval during the random access configuration period, a second signal that activates a second random access configuration that includes a second pattern of additional random access occasions, wherein at least a subset of additional random access occasions of the second pattern of additional random access occasions are available for transmission for a time duration beginning at a start time, wherein the start time is based on a reference time which is based at least in part on the time interval; and obtaining, from at least one of the one or more UEs and after the start time, a random access message in a random access occasion of the second pattern of additional random access occasions based at least in part on the second random access configuration.

Aspect 19: The method of aspect 18, wherein the time interval is a slot, and the reference time is one of a beginning time or an end time of the slot.

Aspect 20: The method of aspect 18, wherein the time interval is a frame, and wherein the reference time is one of a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

Aspect 21: The method of aspect 18, wherein outputting the second signal comprises: outputting the second signal via a paging message during a paging cycle, wherein the time interval is the paging cycle, and wherein the reference time is one of: a beginning time or an end time of a temporally first slot within the paging cycle, a beginning time or an end time of a temporally last slot within the paging cycle, or a beginning time or an end time of a temporally first slot after the paging cycle.

Aspect 22: The method of any of aspects 18 through 21, wherein the start time is offset from the reference time by a quantity of association periods in accordance with the first random access configuration.

Aspect 23: The method of any of aspects 18 through 22, wherein the start time is offset from the reference time by a quantity of association periods in accordance with the second random access configuration.

Aspect 24: The method of any of aspects 18 through 23, wherein the start time is offset from the reference time by a quantity of PRACH configuration periods.

Aspect 25: The method of aspect 24, further comprising: calculating a respective duration of each PRACH configuration period of the quantity of PRACH configuration periods using the first pattern of first random access occasions.

Aspect 26: The method of any of aspects 24 through 25, further comprising: calculating a respective duration of each PRACH configuration period of the quantity of PRACH configuration periods using the second pattern of additional random access occasions.

Aspect 27: The method of any of aspects 24 through 26, further comprising: calculating a respective duration of each PRACH configuration period of the quantity of PRACH configuration periods using both the first pattern of first random access occasions and the second pattern of additional random access occasions.

Aspect 28: The method of any of aspects 18 through 27, wherein the start time is offset from the reference time by a quantity of association pattern periods.

Aspect 29: The method of any of aspects 18 through 28, wherein the start time is offset from the reference time by a quantity of SSB to random access occasion mapping cycles associated with the first pattern of first random access occasions.

Aspect 30: The method of any of aspects 18 through 29, wherein the start time is offset from the reference time by a quantity of SSB to random access occasion mapping cycles associated with the second pattern of additional random access occasions.

Aspect 31: The method of any of aspects 18 through 30, further comprising: outputting, after output of the second signal and before an end of the time duration, a third signal that activates the second random access configuration; and resetting, based at least in part on output of the third signal, the time duration relative to a receipt time of the third signal.

Aspect 32: The method of any of aspects 18 through 30, further comprising: outputting, after output of the second signal and before an end of the time duration, a third signal that activates the second random access configuration; and terminating activation of the second random access configuration at an end of the time duration.

Aspect 33: The method of any of aspects 18 through 30, further comprising: outputting, after output of the second signal and before an end of the time duration, a third signal that activates the second random access configuration; and extending, based at least in part on reception of the third signal, the time duration from an end time of the time duration by a second duration equal to the time duration.

Aspect 34: The method of any of aspects 18 through 33, further comprising: transmitting, within the time interval to one or more second UEs, one or more respective second signals that indicate the second random access configuration, wherein the start time is common to the one or more UEs and the one or more second UEs.

Aspect 35: A method for wireless communications at a UE, comprising: receiving a first signal that indicates a first random access configuration that includes a first pattern of first random access occasions available during a random access configuration period; receiving, during the random access configuration period, a second signal that activates a second random access configuration that includes a second pattern of additional random access occasions, wherein at least a subset of additional random access occasions of the second pattern of additional random access occasions are available for transmission for a time duration beginning at a start time; receiving, after receipt of the second signal and before an end of the time duration, a third signal that activates the second random access configuration; and transmitting, after receipt of the third signal, a random access message in a random access occasion of the second pattern of additional random access occasions based at least in part on the second random access configuration, wherein transmission of the random access message is in accordance with a rule associated with receipt of the third signal after the receipt of the second signal and before the end of the time duration.

Aspect 36: The method of aspect 35, further comprising: resetting, in accordance with the rule, the time duration relative to a receipt time of the third signal.

Aspect 37: The method of aspect 35, further comprising: terminating, in accordance with the rule, activation of the second random access configuration at an end of the time duration.

Aspect 38: The method of aspect 35, further comprising: extending, in accordance with the rule, the time duration from an end time of the time duration by a second duration equal to the time duration.

Aspect 39: A method for wireless communications at a network entity, comprising: outputting a first signal that indicates a first random access configuration that includes a first pattern of first random access occasions available during a random access configuration period; outputting, to one or more user equipments (UEs) during the random access configuration period, a second signal that activates a second random access configuration that includes a second pattern of additional random access occasions, wherein at least a subset of additional random access occasions of the second pattern of additional random access occasions are available for transmission for a time duration beginning at a start time; outputting, to the one or more UEs after output of the second signal and before an end of the time duration, a third signal that activates the second random access configuration; and obtaining, from at least one UE of the one or more UEs and after output of the third signal, a random access message in a random access occasion of the second pattern of additional random access occasions based at least in part on the second random access configuration, wherein the random access message is obtained in accordance with a rule associated with the output of the third signal after the output of the second signal and before the end of the time duration.

Aspect 40: The method of aspect 39, further comprising: resetting, in accordance with the rule, the time duration relative to a receipt time of the third signal.

Aspect 41: The method of aspect 39, further comprising: terminating, in accordance with the rule, activation of the second random access configuration at an end of the time duration.

Aspect 42: The method of aspect 39, further comprising: extending, in accordance with the rule, the time duration from an end time of the time duration by a second duration equal to the time duration.

Aspect 43: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 17.

Aspect 44: A UE for wireless communications, comprising at least one means for performing a method of any of aspects 1 through 17.

Aspect 45: A non-transitory computer-readable medium storing code for wireless communications, the code comprising instructions executable by at least one processor (e.g., directly, indirectly, after pre-processing, without pre-processing) to perform a method of any of aspects 1 through 17.

Aspect 46: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 18 through 34.

Aspect 47: A network entity for wireless communications, comprising at least one means for performing a method of any of aspects 18 through 34.

Aspect 48: A non-transitory computer-readable medium storing code for wireless communications, the code comprising instructions executable by at least one processor (e.g., directly, indirectly, after pre-processing, without pre-processing) to perform a method of any of aspects 18 through 34.

Aspect 49: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 35 through 38.

Aspect 50: A UE for wireless communications, comprising at least one means for performing a method of any of aspects 35 through 38.

Aspect 51: A non-transitory computer-readable medium storing code for wireless communications, the code comprising instructions executable by at least one processor (e.g., directly, indirectly, after pre-processing, without pre-processing) to perform a method of any of aspects 35 through 38.

Aspect 52: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 39 through 42.

Aspect 53: A network entity for wireless communications, comprising at least one means for performing a method of any of aspects 39 through 42.

Aspect 54: A non-transitory computer-readable medium storing code for wireless communications, the code comprising instructions executable by at least one processor (e.g., directly, indirectly, after pre-processing, without pre-processing) to perform a method of any of aspects 39 through 42.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first signal that indicates a first random access configuration that includes a first pattern of first random access occasions available during a random access configuration period;
receive, within a time interval during the random access configuration period, a second signal that activates a second random access configuration that includes a second pattern of additional random access occasions, wherein at least a subset of additional random access occasions of the second pattern of additional random access occasions are available for transmission for a time duration beginning at a start time, wherein the start time is based on a reference time which is based at least in part on the time interval; and
transmit, after the start time, a random access message in a random access occasion of the second pattern of additional random access occasions based at least in part on the second random access configuration.

2. The UE of claim 1, wherein:
the time interval is a frame; and
the reference time is one of: a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

3. The UE of claim 1, wherein, to receive the second signal, the one or more processors are individually or collectively operable to execute the code to cause the UE to:
receive the second signal via a paging message during a paging cycle, wherein the time interval is the paging cycle, and wherein the reference time is one of: a beginning time or an end time of a temporally first slot within the paging cycle, a beginning time or an end time of a temporally last slot within the paging cycle, or a beginning time or an end time of a temporally first slot after the paging cycle.

4. The UE of claim 1, wherein the start time is offset from the reference time by a quantity of association periods in accordance with the first random access configuration.

5. The UE of claim 1, wherein the start time is offset from the reference time by a quantity of association periods in accordance with the second random access configuration.

6. The UE of claim 1, wherein the start time is offset from the reference time by a quantity of physical random access channel configuration periods.

7. The UE of claim 6, wherein the one or more processors are individually or collectively further operable to execute the code to cause the UE to:
calculate a respective duration of each physical random access channel configuration period of the quantity of physical random access channel configuration periods using the first pattern of first random access occasions.

8. The UE of claim 6, wherein the one or more processors are individually or collectively further operable to execute the code to cause the UE to:
calculate a respective duration of each physical random access channel configuration period of the quantity of physical random access channel configuration periods using the second pattern of additional random access occasions.

9. The UE of claim 6, wherein the one or more processors are individually or collectively further operable to execute the code to cause the UE to:
calculate a respective duration of each physical random access channel configuration period of the quantity of physical random access channel configuration periods using both the first pattern of first random access occasions and the second pattern of additional random access occasions.

10. The UE of claim 1, wherein the start time is offset from the reference time by a quantity of association pattern periods.

11. The UE of claim 1, wherein the start time is offset from the reference time by a quantity of synchronization signal block to random access occasion mapping cycles associated with the first pattern of first random access occasions.

12. The UE of claim 1, wherein the start time is offset from the reference time by a quantity of synchronization signal block to random access occasion mapping cycles associated with the second pattern of additional random access occasions.

13. The UE of claim 1, wherein the one or more processors are individually or collectively further operable to execute the code to cause the UE to:
receive, after receipt of the second signal and before an end of the time duration, a third signal that activates the second random access configuration; and
reset, based at least in part on reception of the third signal, the time duration relative to a receipt time of the third signal.

14. The UE of claim 1, wherein the one or more processors are individually or collectively further operable to execute the code to cause the UE to:
receive, after receipt of the second signal and before an end of the time duration, a third signal that activates the second random access configuration; and
terminate activation of the second random access configuration at an end of the time duration.

15. The UE of claim 1, wherein the one or more processors are individually or collectively further operable to execute the code to cause the UE to:
receive, after receipt of the second signal and before an end of the time duration, a third signal that activates the second random access configuration; and
extend, based at least in part on reception of the third signal, the time duration from an end time of the time duration by a second duration equal to the time duration.

16. The UE of claim 1, wherein the start time is common to all UEs that receive an indication of the second random access configuration within the time interval.

17. A method for wireless communications at a user equipment (UE), comprising:
receiving a first signal that indicates a first random access configuration that includes a first pattern of first random access occasions available during a random access configuration period;
receiving, within a time interval during the random access configuration period, a second signal that activates a second random access configuration that includes a second pattern of additional random access occasions, wherein at least a subset of additional random access occasions of the second pattern of additional random access occasions are available for transmission for a time duration beginning at a start time, wherein the start time is based on a reference time which is based at least in part on the time interval; and
transmitting, after the start time, a random access message in a random access occasion of the second pattern of additional random access occasions based at least in part on the second random access configuration.

18. The method of claim 17, wherein the time interval is a frame, and wherein the reference time is one of a beginning time or an end time of a temporally first slot within the frame, a beginning time or an end time of a temporally last slot within the frame, a beginning time or an end time of a temporally first subframe within the frame, a beginning time or an end time of a temporally last subframe within the frame, or a beginning time or an end time of the frame.

19. The method of claim 17, wherein receiving the second signal comprises:
receiving the second signal via a paging message during a paging cycle, wherein the time interval is the paging cycle, and wherein the reference time is one of: a beginning time or an end time of a temporally first slot within the paging cycle, a beginning time or an end time of a temporally last slot within the paging cycle, or a beginning time or an end time of a temporally first slot after the paging cycle.

20. A non-transitory computer-readable medium storing code for wireless communications by a user equipment (UE), the code comprising instruction executable by one or more processors to:
receive a first signal that indicates a first random access configuration that includes a first pattern of first random access occasions available during a random access configuration period;
receive, within a time interval during the random access configuration period, a second signal that activates a second random access configuration that includes a second pattern of additional random access occasions, wherein at least a subset of additional random access occasions of the second pattern of additional random access occasions are available for transmission for a time duration beginning at a start time, wherein the start time is based on a reference time which is based at least in part on the time interval; and
transmit, after the start time, a random access message in a random access occasion of the second pattern of additional random access occasions based at least in part on the second random access configuration.
